(19) United States
(12) Patent Application Publication
(10) Pub. No.: US 2023/0368287 A1
(43) Pub. Date: Nov. 16, 2023

(54) SYSTEMS AND METHODS FOR RESOURCE DISBURSEMENT ASSOCIATED WITH DUAL-FEATURE PAYMENT INSTRUMENTS

(71) Applicant: Synchrony Bank, Stamford, CT (US)

(72) Inventors: Gregg Peters, Stamford, CT (US); Falko Kloepper, Stamford, CT (US); Patrick Gamgort, Stamford, CT (US)

(21) Appl. No.: 18/315,156

(22) Filed: May 10, 2023

Related U.S. Application Data
(60) Provisional application No. 63/341,133, filed on May 12, 2022.

(51) Int. Cl. G06Q 40/02; G06Q 30/0279; G06N 20/00

(52) U.S. Cl. CPC G06Q 40/02; G06Q 30/0279; G06N 20/00

(57) ABSTRACT

Systems and methods for resource disbursements associated with secured and unsecured payment instruments. In response to either a request to graduate or cancel a secured payment instrument, a deposit disbursement system can automatically disburse an amount corresponding to a deposit provided for issuance of the secured payment instrument. The disbursement of this amount can be performed automatically according to selection of one or more disbursement options from a set of disbursement options that are automatically, and dynamically, provided using a machine learning algorithm according to various factors corresponding to an account associated with the secured payment instrument.

### CROSS-REFERENCE TO RELATED APPLICATIONS

The present patent application claims the priority benefit of U.S. Provisional Patent Application No. 63/341,133 filed May 12, 2022, the disclosures of which are incorporated by reference herein.

### FIELD

The present disclosure relates generally to resource disbursements associated with secured and unsecured payment instruments. In one example, the systems and methods described herein may be used to automatically disburse an amount corresponding to a deposit provided for issuance of a secured payment instrument in response to either graduation of the secured payment instrument to an unsecured payment instrument or termination of the account associated with the secured payment instrument. Further, the systems and methods described herein may automatically, and dynamically, provide different options for disbursement of the amount based on various factors corresponding to the account associated with the secured payment instrument.

### SUMMARY

Disclosed embodiments may provide a framework to automatically disburse amounts corresponding to security deposits associated with different secured payment instruments in response to either graduation or cancellation of these secured payment instruments. According to some embodiments, a computer-implemented method is provided. The computer-implemented method comprises detecting that an offer to graduate a secured dual-feature payment instrument to an unsecured dual-feature payment instrument is available. The secured dual-feature payment instrument is secured by a security deposit and is associated with a payment instrument account. The computer-implemented method further comprises identifying an available security deposit amount for disbursement. The available security deposit amount is identified based on the security deposit and a balance associated with the payment instrument account. The computer-implemented method further comprises training a machine learning algorithm to identify a set of disbursement options for disbursement of the available security deposit amount. The machine learning algorithm is trained using the account and historical data corresponding to previous disbursements of security deposits associated with other secured dual-feature payment instruments. The computer-implemented method further comprises providing the set of disbursement options. The computer-implemented method further comprises receiving input corresponding to a selection of one or more disbursement options from the set of disbursement options. The computer-implemented method further comprises automatically disbursing the available security deposit amount to one or more endpoints. The one or more endpoints correspond to the selected one or more disbursement options. Further, wherein the available security deposit amount is automatically disbursed as a result of detecting that the offer to graduate to the unsecured dual-feature payment instrument has been accepted. The computer-implemented method further comprises updating the machine learning algorithm. The machine learning algorithm is updated using the payment instrument account, the historical data, and the selected one or more disbursement options.

In some embodiments, the computer-implemented method further comprises using a portion of the security deposit to settle the balance associated with the account.

In some embodiments, the computer-implemented method further comprises, determining that a disbursement option of the set of disbursement options is no longer valid. The computer-implemented method further comprises dynamically updating the set of disbursement options in real-time to remove the disbursement option that is no longer valid. The computer-implemented method further comprises providing the updated set of disbursement options.

In some embodiments, the set of disbursement options include a bank account deposit. Further, the bank account deposit corresponds to a bank account specified in the payment instrument account.

In some embodiments, the set of disbursement options include an option to donate the available security deposit amount to a charitable organization. Further, the option to donate the available security deposit amount includes a listing of charitable organizations.

In some embodiments, the offer and the set of disbursement options are provided concurrently.

In some embodiments, the computer-implemented method further comprises receiving a manual selection of an alternative disbursement option. The alternative disbursement option is not part of the set of disbursement options. The computer-implemented method further comprises updating the machine learning algorithm using the manual selection of the alternative disbursement option.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 shows an illustrative example of an environment in which a deposit corresponding to a secured payment instrument is disbursed according to one or more disbursement options selected during a graduation or cancellation process in accordance with at least one embodiment;

FIG. 2 shows an illustrative example of an environment in which one or more disbursement options are generated and presented in response to a disbursement request in accordance with at least one embodiment;

FIG. 3 shows an illustrative example of an environment in which an option generation algorithm processes user and disbursement records to generate one or more disbursement options and is retrained according to option selections in accordance with at least one embodiment;

FIG. 4 shows an illustrative example of an environment in which a customer is presented with a set of disbursement options for disbursement of a previously provided deposit associated with a secured payment instrument during a graduation process in accordance with at least one embodiment;

FIG. 5 shows an illustrative example of an environment in which a customer is presented with a set of disbursement options for disbursement of a previously provided deposit associated with a secured payment instrument in response to a request to cancel the secured payment instrument in accordance with at least one embodiment;

FIG. 6 shows an illustrative example of a process for identifying and providing one or more disbursement options for disbursement of an available deposit amount in response to detecting that a user is approved for graduation of a secured payment instrument in accordance with at least one embodiment;

FIG. 7 shows an illustrative example of a process for identifying and providing one or more disbursement options for disbursement of an available deposit amount in response to a request to cancel an account associated with a secured payment instrument in accordance with at least one embodiment;

FIG. 8 shows an illustrative example of a process for disbursing a deposit amount associated with a secured payment instrument according to one or more selected disbursement options in accordance with at least one embodiment; and

FIG. 9 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide a framework for automatic disbursement of resources associated with a deposit provided for issuance of a secured payment instrument. For instance, if the systems and methods described herein determines that a secured payment instrument may be graduated to an unsecured payment instrument, these systems and methods described herein may present an offer of graduation to an account holder associated with the secured payment instrument. Through this offer, the systems and methods described herein may automatically, and dynamically, provide different options for disbursement of a deposit amount based on various factors corresponding to the account associated with the secured payment instrument. Similarly, if an account holder associated with the secured payment instrument submits a request to cancel their account, the systems and methods described herein may automatically, and dynamically, provide different options for disbursement of a deposit amount associated with the account, as well as an option to utilize some or all of the deposit amount to remove any outstanding amounts associated with the account.

A secured dual-feature payment instrument may be a payment instrument associated with an account that is secured by a deposit provided by an account holder and held in escrow by the dual-feature payment instrument service. An unsecured dual-payment instrument may be a payment instrument associated with an account that is not secured by a deposit. Graduation of a secured dual-feature payment instrument to an unsecured dual-feature payment instrument may include converting the secured dual-feature payment instrument to an unsecured dual-feature payment instrument by, for example, returning the security deposit for the dual-feature payment instrument (including generating and providing one or more options for automatic disbursement of the security deposit), adjusting the credit limit of the dual-feature payment instrument, updating various credit reporting agencies of the graduation, and other such operations. Graduation of a secured dual-feature payment instrument to an unsecured dual-feature payment instrument may also be referred to herein as a promotion of a secured dual-feature payment instrument to an unsecured dual-feature payment instrument.

As used herein and unless otherwise made expressly clear, “promotion” of a secured dual-feature payment instrument to an unsecured dual-feature payment instrument refers to the systems and methods described herein for graduating a secured dual-feature payment instrument to an unsecured dual-feature payment instrument rather than the conventional meaning of “promotion” (e.g., offering an incentive to promote participation or engagement with services associated with the dual-feature payment instrument). Further, as used herein, a “dual-feature payment instrument” is a payment instrument that is initially secured by a deposit and that can be graduated to an unsecured payment instrument based on one or more criteria, as described in greater detail herein.

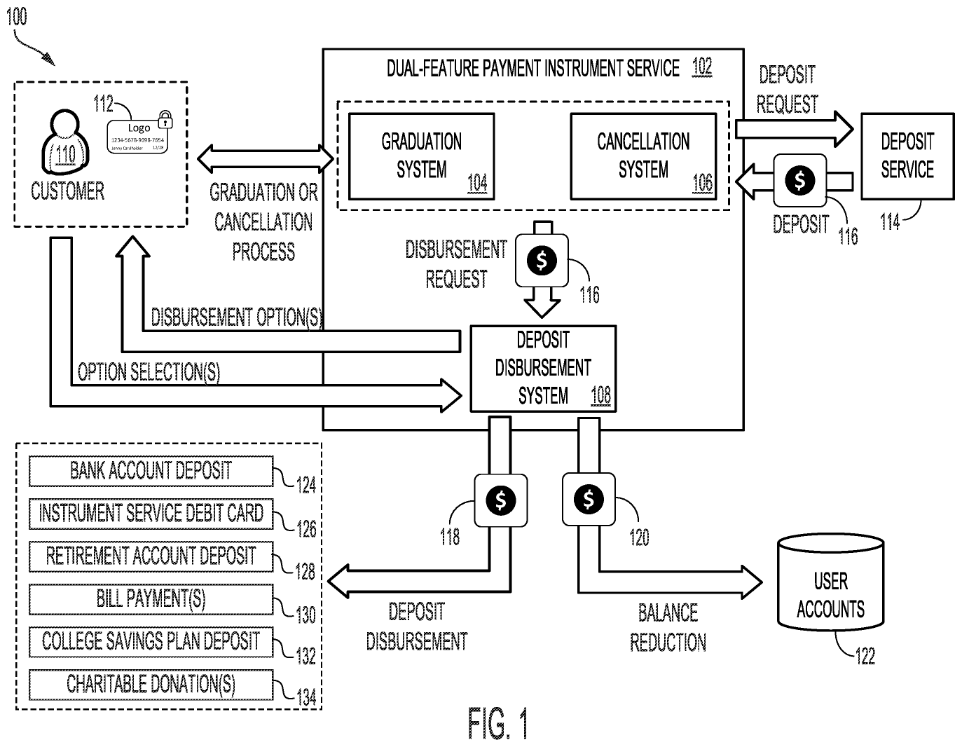

FIG. 1 shows an illustrative example of an environment 100 in which a deposit corresponding to a secured payment instrument 112 is disbursed according to one or more disbursement options selected during a graduation or cancellation process in accordance with at least one embodiment. In the environment 100, a customer 110 of a dual-feature payment instrument service 102 may transmit a request to the dual-feature payment instrument service 102 to either accept an offer for promotion of a secured dual-feature payment instrument 112 to an unsecure dual-feature payment instrument or to request cancellation of an account associated with the secured dual-feature payment instrument 112. In an embodiment, the customer 110 is a user associated with an account provided by the dual-feature payment instrument service 102 or other entity associated with the dual-feature payment instrument service 102 (e.g., a third-party payment instrument service, a merchant, etc.).

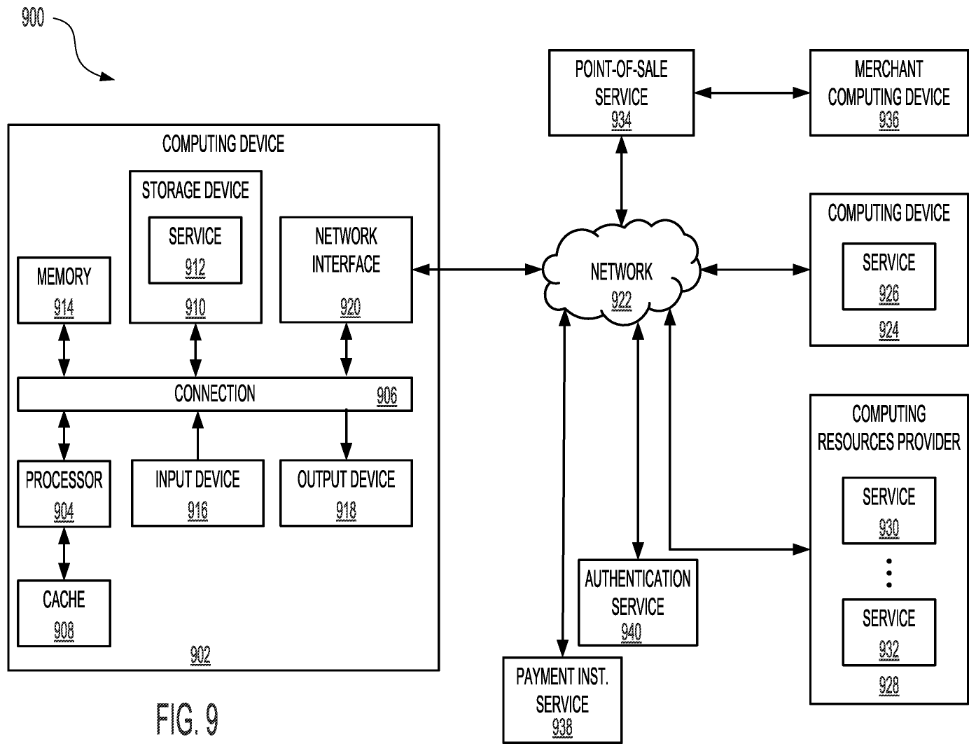

The dual-feature payment instrument service 102, in an embodiment, is a service that, for example, processes applications for secured dual-feature payment instruments, issues secured dual-feature payment instruments, receives deposits used to secure the secured dual-feature payment instruments, processes transactions associated with secured dual-feature payment instruments, determines whether a secured dual-feature payment instrument should be graduated to an unsecured dual-feature payment instrument, processes the graduation of the secured dual-feature payment instrument to an unsecured dual-feature payment instrument, issues unsecured dual-feature payment instruments, processes transactions associated with unsecured dual-feature payment instruments, processes cancellations of accounts associated with secured and unsecured dual-feature payment instruments, and performs other such operations. In an embodiment, the dual-feature payment instrument service 102 is a service such as the service 912 described herein at least in connection with FIG. 9. In an embodiment, the dual-feature payment instrument service 102 is a service provided by a merchant such as the merchants described herein at least in connection with FIG. 9. In an embodiment, the dual-feature payment instrument service 102 is a service provided by a computing resources provider such as the computing resource provide 928 described herein at least in connection with FIG. 9 (e.g., a service such as service 930 and/or service 932 described herein at least in connection with FIG. 9). In an embodiment, the dual-feature payment instrument service 102 is a payment instrument service such as the payment instrument service 938 described herein at least in connection with FIG. 9. In some instances, the dual-feature payment instrument service 102 may be a service operated by the issuer of the secured dual-feature payment instrument and/or the unsecured dual-feature payment instrument. In some instances, the dual-feature payment instrument service 102 may be a service operated by a third-party on behalf of the issuer of the secured dual-feature payment instrument and/or the unsecured dual-feature payment instrument.

The account associated with a secured dual-feature payment instrument 112 may be associated with a deposit that is used to provide secured funds for charges made using the secured dual-feature payment instrument 112. For example, a secured dual-feature payment instrument may have a credit limit of five-hundred dollars (e.g., have an unpaid balance of up to five-hundred dollars). Such a secured dual-feature payment instrument may be secured by a deposit of five-hundred dollars. In an embodiment, a security deposit 116 for a secured dual-feature payment instrument 112 is equal to the credit limit of the secured dual-feature payment instrument (e.g., the security deposit 116 is five-hundred dollars for a secured dual-feature payment instrument with a credit limit of five-hundred dollars). In some instances, the security deposit 116 for a secured dual-feature payment instrument may be less than the credit limit of the secured dual-feature payment instrument 112 (e.g., the security deposit 116 is two-hundred dollars for a secured dual-feature payment instrument with a credit limit of five-hundred dollars). In some instances, the credit limit of the secured dual-feature payment instrument may not exceed the amount of the security deposit 116. In such instances, the credit limit of the secured dual-feature payment instrument may be equal to the security deposit (e.g., two-hundred dollars) or may be less than the security deposit (e.g., one-hundred dollars). In some instances, a security deposit 116 for a secured dual-feature payment instrument is less than the credit limit of the secured dual-feature payment instrument (e.g., the security deposit 116 is one-thousand dollars for a secured dual-feature payment instrument with a credit limit of five-hundred dollars).

The deposit 116 associated with the secured dual-feature payment instrument 112 may be maintained by a deposit service 114, which may hold the deposit 116 in escrow on behalf of the dual-feature payment instrument service 102. The deposit service 114 may hold the security deposit 116 in an account and the security deposit 116 may be released when certain conditions are met. For example, the deposit service 114 may release the security deposit 116 in response to a request to graduate the secured dual-feature payment instrument 112 to an unsecured dual-feature payment instrument. As another illustrative example, the deposit service 114 may release the security deposit 116 in response to a request to cancel the account associated with the secured dual-feature payment instrument 112. The deposit service 114 may be implemented as a component of the dual-feature payment instrument service 102. Alternatively, the deposit service 114 may be implemented as a third-party service that operates separately from the dual-feature payment instrument service 102. In some instances, the deposit service 114 may be associated with a payment instrument service, such as payment instrument service 938 described herein in connection with FIG. 9.

The secured dual-feature payment instrument 112 may be implemented as a physical card that is issued to the customer 110 by the dual-feature payment instrument service 102 (e.g., by mailing the physical card to the customer 110, etc.). In some instances, account information associated with the secured dual-feature payment instrument 112 may be sent electronically to a merchant-specific wallet (e.g., an electronic wallet associated with a merchant that may be used in transactions associated with the merchant. The account information associated with the secured dual-feature payment instrument 112 provided to the merchant specific wallet may be sent in addition to a physical card provided to the customer 110. In an embodiment, the secured dual-feature payment instrument 112 is provided as a virtual secured dual-feature payment instrument to the customer 110 by, for example, establishing an account for the customer 110 using a payment instrument service, a service provided by a merchant, a service provided by a computing resources provider, and the like. The virtual secured dual-feature payment instrument may be implemented in a digital wallet usable by the customer 110 via a device such as a smart phone, smart watch, or other such device. The virtual secured dual-feature payment instrument may also be implemented so that it is associated with an online account (e.g., PayPal®, Venmo®, etc.) and is usable only in association with that online account.

In an embodiment, a graduation system 104 implemented by the dual-feature payment instrument service 102 can automatically monitor transactions of the secured dual-feature payment instrument 112 to determine whether an offer of graduation may be provided to the customer 110. The graduation system 104 may be implemented using a computer system of the dual-feature payment instrument service 102. In some instances, the graduation system 104 may be implemented as an application or executable process that is executed on a computer system of the dual-feature payment instrument service 102. In an embodiment, the determination of whether a secured dual-feature payment instrument 112 should be graduated to an unsecured dual-feature payment instrument and/or to trigger the processing of the graduation of the secured dual-feature payment instrument to an unsecured dual-feature payment instrument is based on pre-determined criteria including, but not limited to, spending habits over a period of time, payment performance over a period of time, changes in credit scores over a period of time, and the like.

In an embodiment, the graduation system 104 implements a machine learning algorithm or artificial intelligence that is dynamically trained in real-time to determine whether a secured dual-feature payment instrument 112 should be graduated to an unsecured dual-feature payment instrument and/or to trigger the processing of the graduation of the secured dual-feature payment instrument 112 to an unsecured dual-feature payment instrument. For example, the graduation system 104 may implement and dynamically train, in real-time, a clustering algorithm to identify similar accounts, account holders, and/or secured dual-feature payment instruments based on one or more vectors of similarity between the account being evaluated and other clusters of account graduation determinations. These vectors of similarity may include, but are not limited to, spending habits, credit limits, payment performance, demographic information, credit scores, changes in credit scores, and the like. In some instances, a dataset of sample characteristics of accounts, customers, and/or secured dual-feature payment instruments may be analyzed using a clustering algorithm to determine whether a secured dual-feature payment instrument should be graduated to an unsecured dual-feature payment instrument and/or to trigger the processing of the graduation of the secured dual-feature payment instrument to an unsecured dual-feature payment instrument. Thus, in some embodiments, the graduation system 104, through the machine learning algorithm or artificial intelligence, can perform such clustering and obtain partial matches among other clusters of graduation determinations to identify a particular cluster and, from this cluster, determine whether the secured dual-feature payment instrument may be graduated to an unsecured dual-feature payment instrument.

Example clustering algorithms may be trained using the collected dataset. In an embodiment, clustering algorithms are trained using sample datasets of characteristics of accounts, customers, and/or secured dual-feature payment instruments to classify accounts, customers, and/or secured dual-feature payment instruments in order to identify secured dual-feature payment instruments that should be graduated to unsecured dual-feature payment instruments and/or to trigger the processing of the graduation of the secured dual-feature payment instrument 112 to an unsecured dual-feature payment instrument. Examples of such clustering algorithms may include, but are not be limited to, k-means clustering algorithms, fuzzy c-means (FCM) algorithms, expectation-maximization (EM) algorithms, hierarchical clustering algorithms, density-based spatial clustering of applications with noise (DBSCAN) algorithms, and the like.

It should be noted that the machine learning algorithm or artificial intelligence may be dynamically trained, in real-time, to continuously, and automatically, process and monitor transactions of different secured dual-feature payment instruments to determine whether offers of graduation may be provided to the corresponding account holders. This continuous processing and monitoring of these different transactions may be performed independently and in parallel for myriad secured dual-feature payment instruments associated with different customers in real-time and as these different transactions occur. Further, the machine learning algorithm or artificial intelligence may be continuously updated, in real-time, as graduation determinations are made and as secured dual-feature payment instruments are graduated to unsecured dual-feature payment instruments. In some instances, transactions associated with unsecured dual-feature payment instruments may also be monitored in real-time to determine whether corresponding decisioning for graduation of these payment instruments resulted in positive outcomes for the corresponding customers (e.g., customers did not default on their corresponding accounts, customers did not incur significant balances, etc.). These outcomes may be used as feedback corresponding to graduation determinations for different dual-feature payment instruments generated by the machine learning algorithm or artificial intelligence. This, based on outcomes resulting from dual-feature payment instrument graduations, the machine learning algorithm or artificial intelligence may be continuously, and dynamically, updated in real-time to improve or reinforce the accuracy of the machine learning algorithm or artificial intelligence in generating graduation determinations for different secured dual-feature payment instruments associated with different customers.

Based on the output of the machine learning algorithm or artificial intelligence built from an individual account, customer, and/or secured dual-feature payment instrument, a determination of whether a secured dual-feature payment instrument 112 should be graduated to an unsecured dual-feature payment instrument and/or whether to trigger the processing of the graduation of the secured dual-feature payment instrument 112 to an unsecured dual-feature payment instrument, the graduation system 104 may prompt the customer 110 to provide a response as to whether the customer 110 wishes to have the secured dual-feature payment instrument 112 graduated to an unsecured dual-feature payment instrument. In an embodiment, the machine learning algorithm or artificial intelligence can alter and/or otherwise update the pre-determined criteria based on additional data and/or updates to the machine learning algorithm or artificial intelligence. In an embodiment, the determination of whether a secured dual-feature payment instrument 112 should be graduated to an unsecured dual-feature payment instrument and/or to trigger the processing of the graduation of the secured dual-feature payment instrument 112 to an unsecured dual-feature payment instrument is made in concert using a combination of a financial services expert and one or more machine learning algorithms or an artificial intelligence systems.

In an embodiment, the offer for graduation includes information such as the terms for the graduation, an interest rate of the unsecured dual-feature payment instrument, a credit limit of the unsecured dual-feature payment instrument, when the graduation will be effective, whether the graduation is automatically accepted or automatically rejected based on no response by a certain date, and other such information. In an embodiment, the information (e.g., the terms for the graduation, an interest rate of the unsecured dual-feature payment instrument, a credit limit of the unsecured dual-feature payment instrument, when the graduation will be effective, whether the graduation is automatically accepted or automatically rejected based on no response by a certain date, etc.) included with the offer for graduation is provided to the customer 110 at a time when the account and/or the secured dual-feature payment instrument is created. In an embodiment, the information included with the offer for graduation changes during the existence of the account and/or the secured dual-feature payment instrument 112. Changes to this information may be communicated to the customer 110 at a time when the changes occur. In such instances, the customer 110 may have an opportunity to accept or reject the changes by, for example, submitting a request to cancel the account associated with the secured dual-feature payment instrument 112.

In an embodiment, if the customer 110 accepts the offer for graduation of the secured dual-feature payment instrument 112 to an unsecured dual-feature payment instrument, the graduation system 104 submits a disbursement request to a deposit disbursement system 108. For instance, in response to the customer's acceptance of the offer for graduation, the graduation system 104 may submit a request to the deposit service 114 to retrieve the security deposit 116 associated with the customer's account. As the graduation of the secured dual-feature payment instrument 112 to an unsecured dual-feature payment instrument may automatically trigger a disbursement of the security deposit 116 to the customer 110 through any of the available methods as described in greater detail herein, the graduation system 104 may provide the security deposit 116 to the deposit disbursement system 108 in its disbursement request. The deposit disbursement system 108 may be implemented using a computer system of the dual-feature payment instrument service 102. In some instances, the deposit disbursement system 108 may be implemented as an application or executable process that is executed on a computer system of the dual-feature payment instrument service 102.

In response to the disbursement request from the graduation system 104, the deposit disbursement system 108 may automatically identify one or more disbursement options that may be presented to the customer 110 for disbursement of their security deposit 116. In an embodiment, the deposit disbursement system 108 implements a machine learning algorithm or artificial intelligence that is trained to dynamically generate one or more options that may be provided to the customer 110 for disbursement of their security deposit 116. The machine learning algorithm or artificial intelligence implemented by the deposit disbursement system 108 may be trained using supervised, unsupervised, reinforcement, or other such training techniques. For instance, the machine learning algorithm or artificial intelligence may be trained using a dataset comprising sample user account information (e.g., spending habits, credit limits, payment performance, demographic information, credit scores, changes in credit scores, etc.) and disbursement records corresponding to the sample user account information (e.g., user requests for disbursement, actual methods of disbursement used for different sample users, disbursement options presented to different sample users, etc.). This dataset may be analyzed using the machine learning algorithm or artificial intelligence to identify correlations between different elements of the dataset without supervision and feedback. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like.

As an example of a supervised training technique, a dataset can be selected for training of the machine learning algorithm or artificial intelligence to facilitate identification of correlations between user account information and the disbursement methods selected for disbursement of security deposits. The machine learning algorithm or artificial intelligence may be evaluated to determine, based on the sample inputs supplied to the machine learning algorithm or artificial intelligence, whether the machine learning algorithm or artificial intelligence is producing accurate correlations between members of the dataset (e.g., given a user's account information, the machine learning algorithm or artificial intelligence is providing relevant disbursement options for disbursement of a security deposit). As an illustrative example of the training of the machine learning algorithm or artificial intelligence implemented by the deposit disbursement system 108, an evaluator of the machine learning algorithm or artificial intelligence may review the disbursement options generated by the machine learning algorithm or artificial intelligence to determine whether the disbursement options correspond to the user account information and whether these disbursement options are desirable based on the user account information. To determine whether these disbursement options are desirable, the evaluator may evaluate feedback corresponding to the presentation of these disbursement options. This feedback may include acceptance or rejection of presented disbursement options, as well as any explicit feedback provided by a customer 110 or other user to whom the disbursement options are presented (e.g., comments provided by users with regard to presented disbursement options, selection of a feedback option regarding their selection or rejection of a disbursement option, etc.). In some instances, an evaluator may act as a customer or other entity that interacts with the deposit disbursement system 108 in association with acceptance of an offer for graduation of a secured dual-feature payment instrument to an unsecured dual-feature payment instrument. The evaluator may review the disbursement options presented to the evaluator by the deposit disbursement system 108 based on the user account information associated with the evaluator (e.g., hypothetical or sample user account information, actual user account information, etc.) to determine whether the disbursement options presented to the evaluator are desirable or otherwise consistent with the user account information associated with the evaluator. Based on the evaluator's feedback, the machine learning algorithm or artificial intelligence implemented by the deposit disbursement system 108 may be re-trained and/or reinforced to improve the likelihood of the deposit disbursement system 108 providing desirable disbursement options to users, including customer 110.

As noted above, in response to the disbursement request from the graduation system 104, the deposit disbursement system 108 may automatically identify one or more disbursement options that may be presented to the customer 110 using account information associated with the customer 110 as input to a machine learning algorithm or artificial intelligence. As illustrated in FIG. 1, these one or more disbursement options may include a bank account deposit 124, conversion to an instrument service debit card 126 or other payment instrument, a retirement account deposit 128 (e.g., individual retirement accounts (IRAs), Roth IRAs, 401(k)s, and/or 457s for federal employees, etc.), one or more bill payments 130 (e.g., student loan pay down, payment instrument pay down, general bill pay, etc.), a college savings plan deposit 132 (e.g., a 529 plan, etc.), one or more charitable donations 134 (e.g., as designated by the customer 110, selected from a listing of charitable organizations provided by the dual-feature payment instrument service 102, etc.), and the like. In some instances, the deposit disbursement system 108 may provide the customer 110 with an option to disburse the security deposit 116 amongst any combination of the aforementioned disbursement options. As an illustrative and non-limiting example, the deposit disbursement system 108 may allow a customer 110 to allocate, for disbursement of a security deposit 116, a percentage of the resulting funds for deposit into a bank account and another percentage of the funds for deposit into a retirement account. As another illustrative example, the deposit disbursement system 108 may allow the customer 110 to specify a particular monetary amount from the security deposit 116 for each of the available disbursement options presented to the customer 110. The disbursement of the security deposit 116 may be performed automatically by the deposit disbursement system 108 according to the one or more selections made by the customer 110.

The deposit disbursement system 108 may facilitate deployment of all or portions of the security deposit 116 to one or more endpoints determined by the customer 110 through selection of one or more of the available disbursement options. For example, if the customer 110 has indicated that the security deposit 116 is to be deposited in the customer's bank account, the deposit disbursement system 108 may transmit a request to the customer's banking institution to deposit the security deposit 116 into the customer's bank account. In an embodiment, if the customer 110 has specified that a particular percentage of the security deposit 116 is to be deployed to a first endpoint and the remaining percentage of the security deposit 116 is to be deployed to a second endpoint, the deposit disbursement system 108 divides the security deposit 116 according to the customer's percentage allocations and deploys the security deposit 116 to these endpoints accordingly. As another example, the customer 110 may specify a particular monetary amount that is to be deployed to a particular endpoint and indicate that the remaining amount is to be deployed equally amongst a number of other endpoints. The deposit disbursement system 108 may deploy the particular monetary amount to the particular endpoint, calculate the remaining monetary amount, divide this remaining monetary amount based on the number of other endpoints specified by the customer 110, and deploy the divided remaining monetary amount to these other endpoints. Thus, the deposit disbursement system 108 may allow the customer 110 to designate various endpoints and tailor disbursement of funds amongst these various endpoints.

In an embodiment, the deposit disbursement system 108 provides an option, to the customer 110, to use all or a portion of the security deposit 116 to reduce an existing balance associated with the secured dual-feature payment instrument 112 ahead of graduation of the secured dual-feature payment instrument 112 to an unsecured dual-feature payment instrument. For instance, in addition to providing the customer 110 with the one or more available disbursement options for automatic disbursement of the security deposit 116, the deposit disbursement system 108 may present the current balance remaining on the secured dual-feature payment instrument 112, as well as any information corresponding to promotions or other information corresponding to the current balance (e.g., applicable interest rate(s), required payment date(s), balance carryover information, etc.). For example, in addition to providing the current balance remaining on the secured dual-feature payment instrument 112, the deposit disbursement system 108 may indicate what portion of the current balance is subject to a promotional interest rate (e.g., 0% Annual Percentage Rate (APR) for a period of time, etc.), what portion of the current balance will be subject to a new interest rate associated with the unsecured dual-feature payment instrument, and the like. If the customer 110 designates all or a portion of the security deposit 116 for payment of all or a portion of the current balance remaining on the secured dual-feature payment instrument 112, the deposit disbursement system 108 may update the customer's account within the user account datastore 122 to apply the designated amount of the security deposit 116 to the customer's account, thereby reducing or eliminating the customer's account balance.

In an embodiment, the customer's selection of one or more disbursement options for automatic disbursement of the security deposit 116, as well as the operations performed to graduate the secured dual-feature payment instrument 112 to an unsecured dual-feature payment instrument, are used to update the machine learning algorithm or artificial intelligence implemented by the deposit disbursement system 108. For example, when the deposit disbursement system 108 disburses the security deposit 116 according to one or more disbursement options selected by the customer 110 and/or uses the security deposit 116 to reduce the customer's existing balance, these one or more operations may be used to update the machine learning algorithm or artificial intelligence used by the deposit disbursement system 108 as described herein. For instance, if the customer 110 selects one or more disbursement options presented by the deposit disbursement system 108 based on the output of the machine learning algorithm or artificial intelligence (using the customer's account information as input), the deposit disbursement system 108 may use the customer's selection of the one or more disbursement options as a positive indication that the machine learning algorithm or artificial intelligence has accurately selected favorable disbursement options for selection. Alternatively, if the customer 110 rejects the presented disbursement options and, instead, manually selects a method for disbursement of the security deposit 116, the deposit disbursement system 108 may use this as a negative indication that the machine learning algorithm or artificial intelligence has failed to provide disbursement options that are appealing to the customer 110. The customer's selection and/or rejection of the different disbursement options presented by the deposit disbursement system 108 may be used as feedback to reinforce or otherwise retrain the machine learning algorithm or artificial intelligence utilized by the deposit disbursement system 108 to determine what disbursement options are to be presented to similarly situated customers.

It should be noted that the machine learning algorithm or artificial intelligence implemented by the deposit disbursement system 108 may be dynamically trained to continuously process different user account information corresponding to different customers and any available disbursement records corresponding to these user account information as graduation offers are accepted by these different customers. Further, the machine learning algorithm or artificial intelligence implemented by the deposit disbursement system 108 may be continuously updated, in real-time, as deposit disbursement option selections are made by customers for their dual-feature payment instruments. These selections may be used as feedback corresponding to customer adherence to the provided disbursement options generated by the machine learning algorithm or artificial intelligence. Thus, based on these customer selections, the machine learning algorithm or artificial intelligence may be continuously, and dynamically updated in real-time to improve or reinforce the accuracy of the machine learning algorithm or artificial intelligence in generating different deposit disbursement options for different customers and corresponding dual-feature payment instruments.

In addition to a graduation system 104 that may automatically monitor transactions of the secured dual-feature payment instrument 112 to determine whether an offer of graduation may be provided to the customer 110, the dual-feature payment instrument service 102 may implement a cancellation system 106 through which customers of the dual-feature payment instrument service 102 may submit requests to cancel their secured dual-feature payment instruments. The cancellation system 106 may be implemented using a computer system of the dual-feature payment instrument service 102. In some instances, the cancellation system 106 may be implemented as an application or executable process that is executed on a computer system of the dual-feature payment instrument service 102. In an embodiment, the dual-feature payment instrument service 102 provides customers, such as customer 110, with access to the cancellation system 106 via an interface (e.g., a graphical user interface (GUI), dashboard, etc.). Through this interface, a customer 110 may submit a request to the cancellation system 106 to cancel an existing account associated with the secured dual-feature payment instrument 112.

In an embodiment, in response to a request from the customer 110 to cancel an existing account associated with the secured dual-feature payment instrument 112, the cancellation system 106 automatically accesses the user account datastore 122 to determine whether the customer 110 has an existing balance on their account. If the customer 110 has an existing balance on their account, the customer 110 may be required to pay off this existing balance prior to cancelling the account. Accordingly, the cancellation system 106 may update the interface to indicate this existing balance.

If the customer 110 determines that it wishes to proceed with cancellation of the account associated with their secured dual-feature payment instrument 112, the cancellation system 106 may submit a request to the deposit service 114 to retrieve the security deposit 116 associated with the customer's account. Once the security deposit 116 has been retrieved from the deposit service 114, the cancellation system 106 may submit a request to the deposit disbursement system 108 to provide the customer 110 with one or more disbursement options for disbursement of the security deposit 116, minus any amount required to eliminate an existing balance associated with the customer's account. For instance, if the customer 110 has an existing balance associated with their account, the cancellation system 106 may reserve an amount from the security deposit 116 that may be used to automatically settle the existing balance due on the account. Any amount remaining from the security deposit 116 may be made available for disbursement according to any of the one or more disbursement options presented to the customer 110 by the deposit disbursement system 108.

In an embodiment, if the entirety of the security deposit 116 is required to settle the existing balance due on the account, the cancellation system 106 can forego submitting a request to the deposit disbursement system 108, as the entirety of the security deposit 116 is to be used to settle the existing balance. Accordingly, the cancellation system 106 may apply the entirety of the security deposit 116 to the customer's account, such as by applying an amount 120 equivalent to the security deposit 116 to the customer's account in the user account datastore 122. Once the security deposit 116 has been applied to the customer's account, the cancellation system 106 may update the interface utilized by the customer 110 to indicate that the existing balance has been paid. Further, through the interface, the cancellation system 106 may indicate that the account associated with the secured dual-feature payment instrument 112 has been cancelled.

In an embodiment, if the existing balance is less than the amount corresponding to the security deposit 116, the cancellation system 106, in its request to the deposit disbursement system 108, indicates the remaining amount 118 of the security deposit 116 that can be disbursed to the customer 110. Accordingly, the deposit disbursement system 108 may indicate, to the customer 110, the remaining amount 118 of the security deposit 116 that can be disbursed according to one or more options made available to the customer 110. As noted above, the deposit disbursement system 108 may use a machine learning algorithm or artificial intelligence to automatically identify one or more disbursement options that may be presented to the customer 110 for disbursement of the security deposit 116. Thus, the deposit disbursement system 108 may automatically use account information associated with the customer 110 as input to the machine learning algorithm or artificial intelligence to identify one or more disbursement options that may be presented to the customer 110. Based on the customer's selections, the deposit disbursement system 108 may facilitate deployment of the remaining amount 118 of the security deposit 116 to one or more endpoints.

In an embodiment, rather than automatically applying an amount 120 of the security deposit 116 to settle an existing balance, the cancellation system 106 allows the customer 110, through the deposit disbursement system 108, to select one or more disbursement options for disbursement of the entire security deposit 116. However, prior to disbursement of the security deposit 116 according to the selected one or more disbursement options, the customer 110 may be required to provide payment to settle the existing balance. For example, the customer 110 may be required to provide a payment instrument payment, debit payment, or other form of payment to the deposit disbursement system 108 before the deposit disbursement system 108 is able to disburse the security deposit 116 according to the selected one or more disbursement options. In response to receiving a form of payment for the existing balance, the deposit disbursement system 108 may provide this form of payment to the cancellation system 106. The cancellation system 106 may process the form of payment provided by the customer 110 to settle the existing balance. Once the existing balance has been successfully settled, the cancellation system 106 may transmit a balance settlement confirmation to the deposit disbursement system 108. In response to the balance settlement confirmation, the deposit disbursement system 108 may disburse the security deposit 116 according to the selected one or more disbursement options. By allowing the customer 110 to use an alternative form of payment to settle an existing balance, the dual-feature payment instrument service 102 may allow the customer 110 to have full autonomy in determining how the security deposit 116 associated with the secured dual-feature payment instrument 112 is to be disbursed.

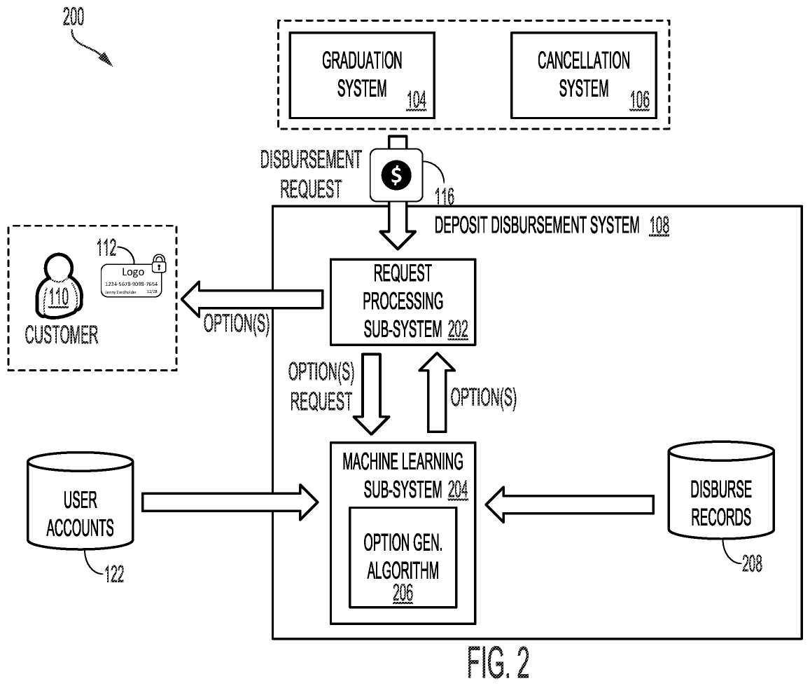

FIG. 2 shows an illustrative example of an environment 200 in which one or more disbursement options are generated and presented in response to a disbursement request in accordance with at least one embodiment. In the environment 200, a graduation system 104 or a cancellation system 106 may submit a request to a deposit disbursement system 108 for disbursement of at least a portion of a security deposit 116 to a customer 110 of the dual-feature payment instrument service. For instance, as noted above, the graduation system 104 may automatically determine whether to provide an offer to the customer 110 to have the secured dual-feature payment instrument 112 graduated to an unsecured dual-feature payment instrument. If the customer 110 accepts the offer, the graduation system 104 may submit a disbursement request to the deposit disbursement system 108 to provide the customer 110 with one or more options for disbursement of the security deposit 116 associated with the secured dual-feature payment instrument 112. As another example, the cancellation system 106 may receive a request from the customer 110 to cancel an account associated with the secured dual-feature payment instrument 112. Accordingly, the cancellation system 106 may use a portion of the security deposit 116 to settle any existing balances associated with the account and submit a disbursement request to the deposit disbursement system 108 to provide the customer 110 with one or more options for disbursement of the remaining amount of the security deposit 116.

The disbursement request from either the graduation system 104 or the cancellation system 106 may be received at a request processing sub-system 202 of the deposit disbursement system 108. The request processing sub-system 202 may be implemented using a computer system of the dual-feature payment instrument service that is associated with the deposit disbursement system 108. In some instances, the request processing sub-system 202 may be implemented as an application or executable process that is executed on a computer system of the dual-feature payment instrument service that is associated with the deposit disbursement system 108. The disbursement request from either the graduation system 104 or the cancellation system 106 may indicate the amount of the security deposit 116 that may be disbursed to the customer 110 or any other entity as indicated by the customer 110 through selection of one or more disbursement options (e.g., a financial institution, a charitable organization, a creditor, etc.). Additionally, the disbursement request may include an identifier corresponding to the account associated with the secured dual-feature payment instrument 112 (e.g., a username, a Primary Account Number (PAN), an alphanumeric account identifier, etc.). This identifier may be used by the request processing sub-system 202 to identify the customer's account from a user account datastore 122.

In an embodiment, in response to the disbursement request from either the graduation system 104 or the cancellation system 106, the request processing sub-system 202 transmits a request to a machine learning sub-system 204 of the deposit disbursement system 108 to identify one or more disbursement options that may be presented to the customer 110. The machine learning sub-system 204 may be implemented using a computer system of the dual-feature payment instrument service that is associated with the deposit disbursement system 108. In some instances, the machine learning sub-system 204 may be implemented as an application or executable process that is executed on a computer system of the dual-feature payment instrument service that is associated with the deposit disbursement system 108. The request transmitted by the request processing sub-system 202 to the machine learning sub-system 204 may include the identifier corresponding to the account associated with the secured dual-feature payment instrument 112. Further, the request may indicate the amount of the security deposit 116 that is available for disbursement to the customer 110 or any other entity as may be indicated by the customer 110.

The machine learning sub-system 204 may implement an option generation algorithm 206 that is configured to automatically, and dynamically, identify one or more disbursement options that may be presented to the customer 110 based on various factors. The option generation algorithm 206, in an embodiment, is a machine learning algorithm or artificial intelligence that is trained to dynamically generate one or more options that may be provided to the customer 110 for disbursement of their security deposit 116. The machine learning algorithm or artificial intelligence implemented by the machine learning sub-system 204, as described above, may be trained using supervised, unsupervised, reinforcement, or other such training techniques. For instance, the option generation algorithm 206 may be trained using a dataset comprising sample user account information (e.g., spending habits, credit limits, payment performance, demographic information, credit scores, changes in credit scores, etc.) and disbursement records corresponding to the sample user account information (e.g., user requests for disbursement, actual methods of disbursement used for different sample users, disbursement options presented to different sample users, etc.). This dataset may be analyzed using the option generation algorithm 206 to identify correlations between different elements of the dataset without supervision and feedback. In some instances, the option generation algorithm 206 may evaluated to determine, based on the sample inputs supplied to the option generation algorithm 206, whether the option generation algorithm 206 is producing accurate correlations between members of the dataset (e.g., given a user's account information, the option generation algorithm 206 is providing relevant disbursement options for disbursement of a security deposit).

It should be noted that the option generation algorithm 206 implemented by the machine learning sub-system 204 may be dynamically trained to continuously process different user account information corresponding to different customers and any available disbursement records corresponding to these user account information as graduation offers are accepted by these different customers. Further, the option generation algorithm 206 implemented by the machine learning sub-system 204 may be continuously updated, in real-time, as deposit disbursement option selections are made by customers for their dual-feature payment instruments. These selections may be used as feedback corresponding to customer adherence to the provided disbursement options generated by the option generation algorithm 206. Thus, based on these customer selections, the option generation algorithm 206 may be continuously, and dynamically updated in real-time to improve or reinforce the accuracy of the option generation algorithm 206 in generating different deposit disbursement options for different customers and corresponding dual-feature payment instruments.

In response to the request from the request processing sub-system 202, the machine learning sub-system 204 may use the identifier corresponding to the account associated with the secured dual-feature payment instrument 112 to query a user account datastore 122 in order to obtain account information corresponding to the secured dual-feature payment instrument 112 and/or the customer 110. The account information may indicate an existing balance for the secured dual-feature payment instrument 112, the credit limit associated with the secured dual-feature payment instrument 112, the available credit associated with the secured dual-feature payment instrument 112, history of payments made to the account over a period of time, any history of missed payments or past-due payments made to the account, and the like. In some instances, the account information corresponding to the secured dual-feature payment instrument 112 and/or the customer 110 may also specify credit scores, changes in credit scores over time, and the like. The account information may further include demographic information associated with the customer 110 and information that may be used to determine the spending habits of the customer 110 (e.g., transaction histories, etc.). This account information, along with information corresponding to the amount of the security deposit 116 that may be disbursed, may be used as input to the option generation algorithm 206.

In addition to the account information and the information corresponding to the amount of the security deposit 116 that may be disbursed, the machine learning sub-system 204 may obtain, from a disbursement records datastore 208, historical data corresponding to previous disbursements made by the deposit disbursement system 108 for customers of the dual-feature payment instrument service. The historical data may include, for each disbursement performed by the deposit disbursement system 108 over time, the one or more disbursement options selected, the total amount of the disbursement, the amount disbursed according to each disbursement option selected, the amount of the original security deposit from which the total amount of the disbursement was issued, information associated with the underlying account (e.g., demographic information, the credit limit associated with the account, the available credit associated with the account, history of payments made to the account over a period of time, any history of missed payments or past-due payments made to the account, credit scores, changes in credit scores over time, etc.). This historical data may be used to dynamically train the option generation algorithm 206 to identify disbursement options that may be presented to customers based on these customers' account information and amounts available for disbursement.

Based on the account information associated with the customer 110, the information corresponding to the amount of the security deposit 116 that may be disbursed, and the historical data from the disbursement records datastore 208, the option generation algorithm 206 may automatically, and dynamically, identify one or more disbursement options that may be presented to the customer 110. As noted above, the one or more disbursement options may include a bank account deposit, conversion to an instrument service debit card or other payment instrument, a retirement account deposit (e.g., individual retirement accounts (IRAs), Roth IRAs, 401(k)s, and/or 457s for federal employees, etc.), one or more bill payments (e.g., student loan pay down, payment instrument pay down, general bill pay, etc.), a college savings plan deposit (e.g., a 529 plan, etc.), one or more charitable donations (e.g., as designated by the customer 110, selected from a listing of charitable organizations provided by the dual-feature payment instrument service, etc.), and the like. In some instances, the option generation algorithm 206 may indicate that the customer 110 may be presented with an option to disburse the available amount from the security deposit 116 amongst any combination of the aforementioned disbursement options. The option generation algorithm 206, through the machine learning sub-system 204, may provide these disbursement options, as well as any parameters corresponding to the selection of these disbursement options (e.g., possible combinations of disbursement options that may be selected, any limits on the disbursement amount per option, etc.), to the request processing sub-system 202.

In response to receiving the disbursement options and the parameters corresponding to the selection of these disbursement options, the request processing sub-system 202 may present the disbursement options to the customer 110. For instance, the request processing sub-system 202 may update an interface used by the customer 110 to access the dual-feature payment instrument service (e.g., GUI, dashboard, etc.) to provide the customer with the identified disbursement options. In some instances, for one or more disbursement options, the request processing sub-system 202 may obtain additional information from the customer's account that may be presented along with these one or more disbursement options. For example, if a disbursement option corresponds to a deposit of an amount from the security deposit 116 to a customer's bank account, the request processing sub-system 202 may determine whether account information corresponding to this bank account is available through the customer's account maintained in the user account datastore 122. If the account information is available, the request processing sub-system 202 may present at least a portion of this account information to the customer 110 via the interface (e.g., last four digits of the bank account number, the name of the financial institution associated with the bank account, etc.). This may allow the customer 110 to readily determine where a specified amount from the security deposit 116 is to be disbursed.

In some instances, if account information is unavailable for one or more disbursement options, the request processing sub-system 202 may prompt the customer 110 to provide the account information in order to select the one or more disbursement options. For example, if the customer 110 selects an option to deposit an amount from the security deposit 116 to their bank account, but the customer's account maintained in the user account datastore 122 does not specify the customer's bank account information, the request processing sub-system 202 may automatically update the interface to prompt the customer 110 to provide their bank account information for the disbursement of the amount from the security deposit 116. As another illustrative example, if the customer 110 selects an option to use an amount from the security deposit 116 to pay a bill, the customer 110 may be prompted to select a recipient of the bill payment (e.g., a utility company, an internet service provider, a financial institution, etc.) and to provide the customer's account information associated with the recipient. If the customer 110 provides account information for one or more disbursement options, the request processing sub-system 202 may update the customer's account within the user account datastore 122 to incorporate this account information. Thus, if the customer 110, at a later time, wishes to disburse an amount from a different security deposit associated with a different secured dual-feature payment instrument, the request processing sub-system 202 may refer to this account information and provide this account information with the corresponding one or more disbursement options.

Based on the customer's selection of one or more disbursement options from those presented by the request processing sub-system 202, the request processing sub-system 202 may facilitate deployment of the available amount from the security deposit 116 to one or more endpoints (e.g., financial institutions, charitable organizations, investment management companies, etc.) as selected by the customer 110 through selection of one or more of the presented disbursement options. For example, if the customer 110 has indicated that the amount available from the security deposit 116 is to be deposited in the customer's bank account, the request processing sub-system 202 may transmit a request to the customer's banking institution to deposit this amount into the customer's bank account (such as through an automated clearing house (ACH) bank transfer or electronic funds transfer (EFT)). In an embodiment, if the customer 110 has specified that a particular percentage of the available amount from the security deposit 116 is to be deployed to a first endpoint and the remaining percentage of the available amount from the security deposit 116 is to be deployed to a second endpoint, the request processing sub-system 202 divides the available amount according to the customer's percentage allocations and deploys the available amount to these endpoints accordingly. As another example, the customer 110 may specify a particular monetary amount that is to be deployed to a particular endpoint and indicate that the remaining amount is to be deployed equally amongst a number of other endpoints. The request processing sub-system 202 may deploy the particular monetary amount to the particular endpoint, calculate the remaining monetary amount, divide this remaining monetary amount based on the number of other endpoints specified by the customer 110, and deploy the divided remaining monetary amount to these other endpoints. Thus, the request processing sub-system 202 may allow the customer 110 to designate various endpoints and tailor disbursement of funds amongst these various endpoints.

As noted above, the deposit disbursement system 108 (through the request processing sub-system 202 and as identified by the machine learning sub-system 204) may provide an option to use all or a portion of the security deposit 116 to reduce an existing balance associated with the secured dual-feature payment instrument 112. For instance, in addition to providing the customer 110 with the one or more available disbursement options for disbursement of the available amount of the security deposit 116, the request processing sub-system 202 may present the current balance remaining on the secured dual-feature payment instrument 112, as well as any information corresponding to promotions or other information corresponding to the current balance. For example, in addition to providing the current balance remaining on the secured dual-feature payment instrument 112, the request processing sub-system 202 may indicate what portion of the current balance is subject to a promotional interest rate, what portion of the current balance will be subject to a new interest rate associated with the unsecured dual-feature payment instrument, and the like. If the customer 110 designates all or a portion of the security deposit 116 for payment of all or a portion of the current balance remaining on the secured dual-feature payment instrument 112, the request processing sub-system 202 may update the customer's account within the user account datastore 122 to apply the designated amount of the security deposit 116 to the customer's account, thereby reducing or eliminating the customer's account balance.

In an embodiment, as customers of the dual-feature payment instrument service select available disbursement options for automatic disbursement of their security deposits, the request processing sub-system 202 may automatically, and in real-time, update the disbursement records datastore 208 to incorporate these disbursements into the historical data corresponding to the disbursements made by the deposit disbursement system 108 for customers of the dual-feature payment instrument service. As noted above, this historical data may be used to dynamically train the option generation algorithm 206 to identify disbursement options that may be presented to customers based on these customers' account information and amounts available for disbursement. Thus, as disbursements of security deposits are performed by the request processing sub-system 202 in response to customer selections from the identified and presented disbursement options, the machine learning sub-system 204 may dynamically, and in real-time, update (e.g., retrain, reinforce, etc.) the option generation algorithm 206 such that, for a new request from the request processing sub-system 202 to identify one or more disbursement options that may be presented to a customer for a given security deposit available for disbursement, the option generation algorithm 206 may be used to identify and provide relevant and appealing disbursement options to the customer.

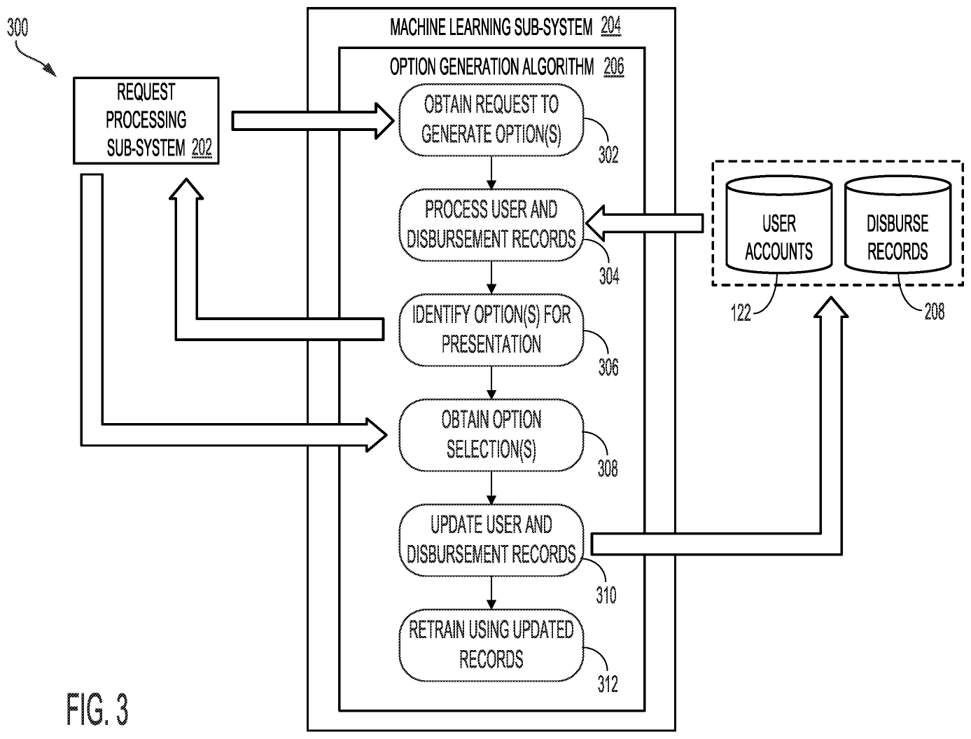

FIG. 3 shows an illustrative example of an environment 300 in which an option generation algorithm 206 processes user and disbursement records to generate one or more disbursement options and is retrained according to option selections in accordance with at least one embodiment. As noted above, a request processing sub-system 202 of the deposit disbursement system may transmit a request to the machine learning sub-system 204 to identify one or more disbursement options that may be presented to a customer for disbursement of an available amount from a security deposit. The machine learning sub-system 204 may implement an option generation algorithm 206 that is dynamically trained to identify disbursement options that may be presented to customers of the dual-feature payment instrument service for disbursement of security deposits as a result of either graduation or cancellation of secured dual-feature payment instruments.

At step 302, the option generation algorithm 206 may obtain a request from the request processing sub-system 202 to generate one or more disbursement options that may be presented to a customer of the dual-feature payment instrument service. The request transmitted by the request processing sub-system 202 to the machine learning sub-system 204 may include an identifier corresponding to the account associated with the secured dual-feature payment instrument that is to be graduated or cancelled. Further, the request may indicate the amount of the security deposit that is available for disbursement to the customer or any other entity as may be indicated by the customer through the request processing sub-system 202.

At step 304, the option generation algorithm 206 may process the user and disbursement records from the user account datastore 122 and the disbursement records datastore 208, respectively. For instance, the option generation algorithm 206 may query the user account datastore 122 using the provided identifier corresponding to the account associated with the secured dual-feature payment instrument to identify customer-specific information. This customer-specific information may indicate an existing balance for the secured dual-feature payment instrument, the credit limit associated with the secured dual-feature payment instrument, the available credit associated with the secured dual-feature payment instrument, history of payments made to the account over a period of time, any history of missed payments or past-due payments made to the account, and the like. As noted above, the customer-specific information corresponding to the secured dual-feature payment instrument and/or the customer may also specify credit scores, changes in credit scores over time, demographic information associated with the customer, information that may be used to determine the spending habits of the customer (e.g., transaction histories, etc.), and the like.

The disbursement records from the disbursement records datastore 208 may include historical data corresponding to previous disbursements made by the deposit disbursement system for customers of the dual-feature payment instrument service. As noted above, the historical data may include, for each disbursement performed by the deposit disbursement system over time, the one or more disbursement options selected, the total amount of the disbursement, the amount disbursed according to each disbursement option selected, the amount of the original security deposit from which the total amount of the disbursement was issued, information associated with the underlying account (e.g., demographic information, the credit limit associated with the account, the available credit associated with the account, history of payments made to the account over a period of time, any history of missed payments or past-due payments made to the account, credit scores, changes in credit scores over time, etc.). This historical data from the disbursement records may be used to dynamically train the option generation algorithm 206 as described above.

At step 306, the option generation algorithm 206 may identify one or more disbursement options for presentation to a customer. For instance, the option generation algorithm 206 may use, as input, the account information associated with the customer, the information corresponding to the amount of the security deposit that may be disbursed, and the historical data from the disbursement records datastore 208 to automatically, and dynamically, identify one or more disbursement options that may be provided to the request processing sub-system 202 for presentation to the customer. As noted above, the one or more disbursement options may include a bank account deposit, conversion to an instrument service debit card or other payment instrument, a retirement account deposit, one or more bill payments, a college savings plan deposit, one or more charitable donations, and the like.

The one or more disbursement options may further include an option to use the security deposit to settle an existing account balance associated with the secured dual-feature payment instrument. For instance, if the account associated with the secured dual-feature payment instrument has a pre-existing balance that is due upon cancellation of the secured dual-feature payment instrument, the option generation algorithm 206 may generate a disbursement option for automatically settling the pre-existing balance prior to cancellation of the secured dual-feature payment instrument. In some examples, if the secured dual-feature payment instrument is being graduated to an unsecured dual-feature payment instrument, and the corresponding account has a pre-existing balance that is to be transferred to the unsecured dual-feature payment instrument, the option generation algorithm 206 may generate a disbursement option for using some or all of the security deposit to settle the pre-existing balance prior to graduation. The disbursement option may be provided with information corresponding to promotions or other information corresponding to the current balance (e.g., applicable interest rate(s), required payment date(s), balance carryover information, etc.). For example, in addition to providing the current balance remaining on the secured dual-feature payment instrument, the disbursement option may include information indicating what portion of the current balance is subject to a promotional interest rate (e.g., 0% APR for a period of time, etc.), what portion of the current balance will be subject to a new interest rate associated with the unsecured dual-feature payment instrument, and the like.

Once the option generation algorithm 206 has identified the one or more disbursement options that are to be presented to the customer, the option generation algorithm 206 may provide these one or more disbursement options to the request processing sub-system 202. In response to receiving the disbursement options and the parameters corresponding to the selection of these disbursement options, the request processing sub-system 202 may present the disbursement options to the customer. Based on the customer's selection of one or more disbursement options from those presented by the request processing sub-system 202, the request processing sub-system 202 may facilitate deployment of the available amount from the security deposit to one or more endpoints (e.g., financial institutions, charitable organizations, investment management companies, etc.) as selected by the customer 110 through selection of one or more of the presented disbursement options. Additionally, the request processing sub-system 202 may provide the customer's selections to the option generation algorithm 206. Thus, at step 308, the option selection algorithm 206 may obtain the disbursement option selections made by the customer and submitted to the request processing sub-system 202.

At step 310, the option generation algorithm 206 may update the user account datastore 122 and the disbursement records datastore 208 to incorporate the customer's disbursement option selections into the historical data that is used to train the option generation algorithm 206. As noted above, the customer's selection of one or more disbursement options for automatic disbursement of the security deposit, as well as the operations performed to graduate the secured dual-feature payment instrument to an unsecured dual-feature payment instrument or to cancel the secured dual-feature payment instrument, are used to update the option generation algorithm 206. For example, when the request processing sub-system 202 disburses the security deposit according to one or more disbursement options selected by the customer and/or uses the security deposit to reduce the customer's existing balance, these one or more operations may be incorporated into the user account datastore 122 and the disbursement records datastore 208 as a new datapoint usable to retrain the option generation algorithm 206. For instance, if the customer selects one or more disbursement options presented by the request processing sub-system 202, the option generation algorithm 206 may use the customer's selection of the one or more disbursement options as a positive indication that the option generation algorithm 206 has accurately selected favorable disbursement options for selection. Alternatively, if the customer rejects the presented disbursement options and, instead, manually selects a method for disbursement of the security deposit, the option generation algorithm 206 may use this as a negative indication that the option generation algorithm 206 has failed to provide disbursement options that are appealing to the customer. The customer's selection and/or rejection of the different disbursement options presented by the request processing sub-system 202 may be used as feedback, at step 312, to reinforce or otherwise retrain the option generation algorithm 206 used to determine what disbursement options are to be presented to similarly situated customers.

As customers select from the available disbursement options for automatic disbursement of their security deposits, the option generation algorithm 206 may automatically, and in real-time, update the disbursement records datastore 208 to incorporate these disbursements into the historical data corresponding to the disbursements made by the deposit disbursement system for these customers. Thus, as disbursements of security deposits are performed by the request processing sub-system 202 in response to customer selections from the identified and presented disbursement options, the machine learning sub-system 204 may dynamically, and in real-time, update (e.g., retrain, reinforce, etc.) the option generation algorithm 206 such that, for a new request from the request processing sub-system 202 to identify one or more disbursement options that may be presented to a customer for a given security deposit available for disbursement, the option generation algorithm 206 may be used to identify and provide relevant and appealing disbursement options to the customer.

It should be noted that while machine learning techniques are used extensively throughout the present disclosure for identifying one or more disbursement options for presentation to a customer, the deposit disbursement system may utilize other techniques to determine which disbursement options may be presented to the customer. For example, in an embodiment, the deposit disbursement system can select one or more disbursement options based on the initial payment method used by the customer 110 for the previously provided security deposit. For instance, if the customer 110 used their checking account associated with a particular financial institution (e.g., bank, credit union, etc.) to provide a security deposit for the secured dual-feature payment instrument, the deposit disbursement system may provide options for disbursement of the deposit into the checking account associated with the particular financial institution, a savings account associated with the particular financial institution, or any other disbursement method not requiring additional customer account information (e.g., retirement accounts, accounts associated with other financial institutions, etc.).

In an embodiment, the deposit disbursement system can automatically, and in real-time, identify and record possible disbursement options based on transaction data obtained as transactions using the secured dual-feature payment instrument occur. For example, if the customer utilizes their secured dual-feature payment instrument to pay a utility bill, the deposit disbursement system may automatically, and in real-time, obtain account information associated with the utility bill. The deposit disbursement system may record this account information in the user account datastore 122 and in association with the particular customer. Thus, in response to a request to generate one or more disbursement options that may be presented to a customer of the dual-feature payment instrument service, the deposit disbursement system may query the user account datastore 122 to obtain customer-specific information that includes the account information associated with the utility bill. This account information associated with the utility bill may, thus, be used to generate a new disbursement option for the previously provided deposit. As another illustrative example, if the customer utilizes their secured dual-feature payment instrument to submit a loan payment, the deposit disbursement system may identify, in real-time and based on the transaction data corresponding to the loan payment, account information and the financial institution associated with the loan. The deposit disbursement system may record this account information and financial institution information in the user account datastore 122 and in association with the particular customer. Thus, the deposit disbursement system may use this account and financial institution information to generate a disbursement option for using the security deposit associated with the secured dual-feature payment instrument to pay down the loan.

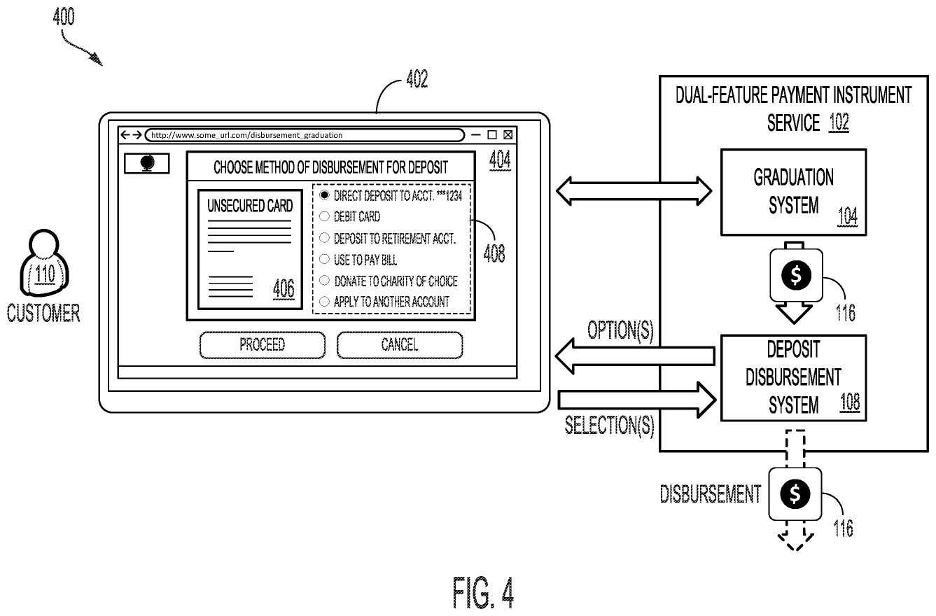

FIG. 4 shows an illustrative example of an environment 400 in which a customer 110 is presented with a set of disbursement options 408 for disbursement of a previously provided security deposit 116 associated with a secured payment instrument during a graduation process in accordance with at least one embodiment. In the environment 400, a customer 110 of the dual-feature payment instrument service 102 uses a computing device 402 to accept an offer for graduation of a secured dual-feature payment instrument to an unsecured dual-feature payment instrument. As noted above, a graduation system 104 of the dual-feature payment instrument service 102 may automatically monitor transactions of the secured dual-feature payment instrument to determine whether an offer of graduation may be provided to the customer 110. The determination of whether a secured dual-feature payment instrument should be graduated to an unsecured dual-feature payment instrument and/or to trigger the processing of the graduation of the secured dual-feature payment instrument to an unsecured dual-feature payment instrument is based on pre-determined criteria including, but not limited to, spending habits over a period of time, payment performance over a period of time, changes in credit scores over a period of time, and the like.

The offer for graduation of the secured dual-feature payment instrument to an unsecured dual-feature payment instrument, in an embodiment, can be presented to the customer 110 simultaneously with one or more disbursement options 408 for disbursement of all or a portion of a security deposit 116 associated with the secured dual-feature payment instrument. For instance, in response to a determination that an offer may be provided to the customer 110 to graduate a secured dual-feature payment instrument to an unsecured dual-feature payment instrument, the graduation system 104 may transmit a request to the deposit disbursement system 108 to identify one or more disbursement options 408 that may be presented to the customer 110 along with the offer. In response to the request from the graduation system 104, the deposit disbursement system 108 may use an option generation algorithm (as described above in connection with FIGS. 2 and 3) to automatically, and dynamically, identify one or more disbursement options that may be presented to the customer 110 based on various factors.

As noted above, the request from the graduation system 104 may include an identifier corresponding to the account associated with the secured dual-feature payment instrument for which the graduation offer is being presented. Further, the request may indicate the amount of the security deposit 116 that is available for disbursement to the customer 110 or any other entity as may be indicated by the customer 110. The option generation algorithm of the deposit disbursement system 108 may use the identifier corresponding to the account to obtain account information corresponding to the secured dual-feature payment instrument and/or the customer 110. The account information may indicate an existing balance for the secured dual-feature payment instrument, the credit limit associated with the secured dual-feature payment instrument, the available credit associated with the secured dual-feature payment instrument, history of payments made to the account over a period of time, any history of missed payments or past-due payments made to the account, and the like. In some instances, the account information corresponding to the secured dual-feature payment instrument and/or the customer 110 may also specify credit scores, changes in credit scores over time, and the like. The account information may further include demographic information associated with the customer 110 and information that may be used to determine the spending habits of the customer 110 (e.g., transaction histories, etc.). This account information, along with information corresponding to the amount of the security deposit 116 that may be disbursed, may be used as input to the option generation algorithm.

The deposit disbursement system 108, through the option generation algorithm, may automatically, and dynamically, identify one or more disbursement options 408 that may be presented to the customer 110. In some instances, the deposit disbursement system 108 may further determine, using the option generation algorithm, that the customer 110 may be presented with an option to disburse the available amount from the security deposit 116 amongst any combination of the aforementioned disbursement options 408. In an embodiment, once the deposit disbursement system 108 has identified the one or more disbursement options 408 that may be presented to the customer 110, the deposit disbursement system 108, through the graduation system 104, may transmit a notification to the customer 110 to indicate that an offer for graduation of their secured dual-feature payment instrument to an unsecured dual-feature payment instrument is available for review. This notification may be transmitted to the customer 110 through one or more communications channels, such as electronic mail (e.g., e-mail), Short Message Service (SMS) message, telephonic communication (e.g., telephone call, voicemail message, etc.), a chat session, through an application 404 provided by the dual-feature payment instrument service 102 and implemented on the computing device 402, and the like. The notification may include a Uniform Resource Identifier (URI) corresponding to a web page or a web portal provided by the dual-feature payment instrument service 102 and that may be accessed using a browser application implemented on the computing device 402.

In response to the notification, the customer 110 may utilize their computing device 402 to access the application 404 provided by the dual-feature payment instrument service 102 in order to review the offer for graduation of their secured dual-feature payment instrument to an unsecured dual-feature payment instrument and to select one or more disbursement options for disbursement of the security deposit 116 associated with the secured dual-feature payment instrument. As noted above, the notification may include a URI corresponding to a web page or web portal provided by the dual-feature payment instrument service 102. Thus, the application 404 may be accessed through this web page or web portal, through which interactions with the dual-feature payment instrument service 102 may be displayed on the computing device 402.

Through the application 404, the graduation system 104 may present an opt-in request 406 to the customer 110, which the customer 110 may review and determine whether to proceed with graduation of their secured dual-feature payment instrument to an unsecured dual-feature payment instrument. In an embodiment, the opt-in request 406 is presented with additional information corresponding to the graduation process. This additional information may include the terms and conditions for the graduation, an interest rate of the unsecured dual-feature payment instrument, a credit limit of the unsecured dual-feature payment instrument, when the graduation will be effective, whether the graduation is automatically accepted or automatically rejected if there is no response by a certain date, and other such information.

In addition to the opt-in request 406, the graduation system 104 may present, through the application 404, the one or more disbursement options 408 identified by the deposit disbursement system 108 and that may be used for disbursement of the security deposit 116 associated with the customer's account. As noted above, additional information from the customer's account may be obtained in order to supplement these one or more disbursement options. For example, if a disbursement option corresponds to a deposit of an amount from the security deposit 116 to a customer's bank account, the deposit disbursement system 108 may determine whether account information corresponding to this bank account is available through the customer's account. If the account information is available, the deposit disbursement system 108, through the graduation system 104, may present at least a portion of this account information to the customer 110 via the application 404 (e.g., last four digits of the bank account number, the name of the financial institution associated with the bank account, etc.). This may allow the customer 110 to readily determine where a specified amount from the security deposit 116 is to be disbursed. In some instances, if account information is unavailable for one or more disbursement options, the deposit disbursement system 108, through the graduation system 104 and the application 404, may prompt the customer 110 to provide the account information in order to select the one or more disbursement options. For example, if the customer 110 selects an option to deposit an amount from the security deposit 116 to their bank account, but the customer's account does not specify the customer's bank account information, the application 404 may be automatically updated to prompt the customer 110 to provide their bank account information for the disbursement of the amount from the security deposit 116. As another illustrative example, if the customer 110 selects an option to use an amount from the security deposit 116 to pay a bill, the customer 110 may be prompted to select a recipient of the bill payment and to provide the customer's account information associated with the recipient. If the customer 110 provides account information for one or more disbursement options, the deposit disbursement system 108 may update the customer's account to incorporate this account information.

In an embodiment, the application 404 includes additional user interface elements to perform additional functions. For example, the application 404 may include a button to decline or cancel the offer for graduation of the secured dual-feature payment instrument to an unsecured dual-feature payment instrument. If the customer 110 selects this button, the application 404 may transmit a response to the graduation system 104 that indicates the customer's rejection of the offer. Additionally, any selections made by the customer 110 among the presented one or more disbursement options 408 may be discarded, as the security deposit 116 may still be required in order to maintain the secured dual-feature payment instrument.

The application 404, in some instances, may further include a button to accept the offer for graduation of the secured dual-feature payment instrument to an unsecured dual-feature payment instrument and to disburse the security deposit 116 according to the customer's selections among the presented one or more disbursement options 408 and/or manually entered disbursement method(s). If the customer 110 selects this button, the application 404 may transmit a response to the graduation system 104 indicating the customer's acceptance of the offer for graduation. This may cause the graduation system 104 to update the customer's account to indicate that the secured dual-feature payment instrument has been graduated or converted to an unsecured dual-feature payment instrument. Further, the graduation system 104 may perform additional operations, such as issuing an unsecured dual-feature payment instrument to the customer 110.

In an embodiment, in addition to updating the customer's account to indicate that the secured dual-feature payment instrument has been graduated or converted to an unsecured dual-feature payment instrument, the graduation system 104 may provide the deposit disbursement system 108 with the one or more disbursement options selected by the customer 110 for disbursement of the security deposit 116. Based on the customer's selection of one or more disbursement options from those presented through the application 404, the deposit disbursement system 108 may facilitate deployment of the available amount from the security deposit 116 to one or more endpoints as selected by the customer 110 through selection of one or more of the presented disbursement options 408 and/or through manual entry of one or more disbursement options through the application 404. For example, if the customer 110 has indicated that the amount available from the security deposit 116 is to be deposited in the customer's bank account, the deposit disbursement system 108 may transmit a request to the customer's banking institution to deposit this amount into the customer's bank account. If the customer 110 has specified that a particular percentage of the available amount from the security deposit 116 is to be deployed to a first endpoint and the remaining percentage of the available amount from the security deposit 116 is to be deployed to a second endpoint, the deposit disbursement system 108 may divide the available amount according to the customer's percentage allocations and may deploy the available amount to these endpoints accordingly. As another example, the customer 110 may specify a particular monetary amount that is to be deployed to a particular endpoint and indicate that the remaining amount is to be deployed equally amongst a number of other endpoints. The deposit disbursement system 108 may deploy the particular monetary amount to the particular endpoint, calculate the remaining monetary amount, divide this remaining monetary amount based on the number of other endpoints specified by the customer 110, and deploy the divided remaining monetary amount to these other endpoints.

In an embodiment, the customer's selection from amongst the available disbursement options 408 and/or manual entry of one or more disbursement methods for automatic disbursement of the security deposit 116, the deposit disbursement system 108 may automatically, and in real-time, incorporate these selections and/or manual entries into the historical data corresponding to the disbursements made by the deposit disbursement system 108 for different customers. As noted above, this historical data may be used to dynamically train the option generation algorithm used by the deposit disbursement system 108 to identify disbursement options that may be presented to customers based on these customers' account information and amounts available for disbursement. Thus, as the disbursements associated with the security deposit 116 are performed by the deposit disbursement system 108 in response to the customer's selections from the identified and presented disbursement options 408 and/or manual entry of one or more disbursement methods, the deposit disbursement system 108 may dynamically, and in real-time, update (e.g., retrain, reinforce, etc.) the option generation algorithm such that, for a new request to identify one or more disbursement options that may be presented to a customer for a given security deposit available for disbursement, the option generation algorithm may be used to identify and provide relevant and appealing disbursement options to the customer.

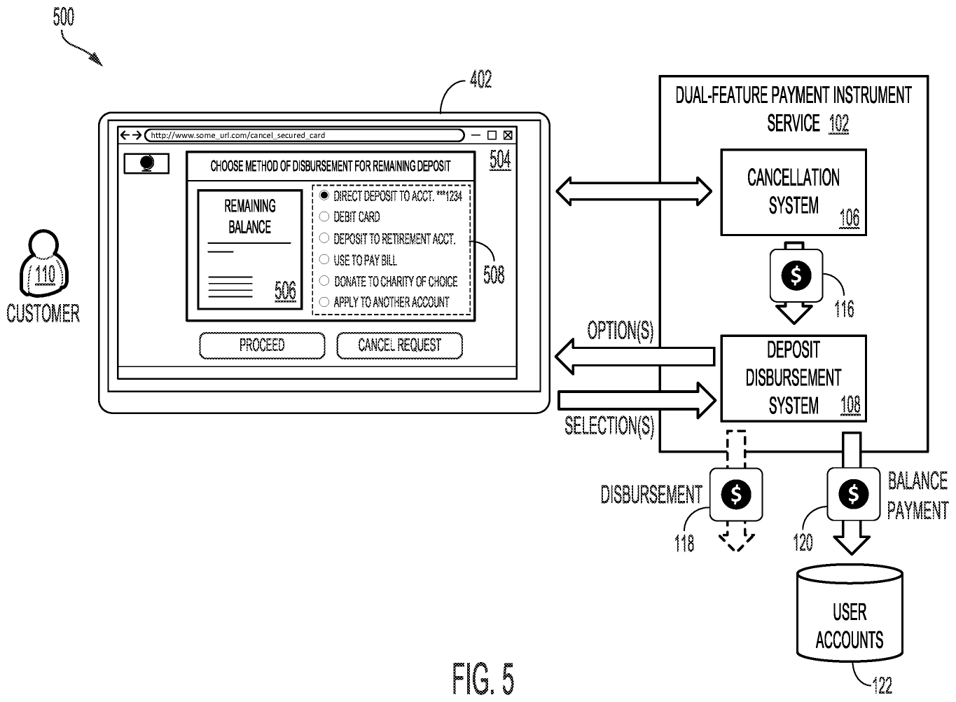

FIG. 5 shows an illustrative example of an environment 500 in which a customer 110 is presented with a set of disbursement options 508 for disbursement of a previously provided deposit 116 associated with a secured payment instrument in response to a request to cancel the secured payment instrument in accordance with at least one embodiment. In the environment 500, a customer 110 of the dual-feature payment instrument service 102 uses a computing device 402 to submit a request to a cancellation system 106 to cancel an existing account associated with a secured dual-feature payment instrument. For instance, through an application 504 provided by the dual-feature payment instrument service 102 and implemented on the computing device 402, the customer 110 may access the dual-feature payment instrument service 102 to submit a request to the cancellation system 106 to cancel an existing account associated with a secured dual-feature payment instrument. In some instances, the application 504 may be accessed through a web page or web portal, through which interactions with the dual-feature payment instrument service 102 may be displayed on the computing device 402.

In response to the request from the customer 110 to cancel their existing account, the cancellation system 106 may automatically access the user account datastore 122 to determine whether the customer 110 has an existing balance on their account. If the customer 110 has an existing balance on their account, the customer 110 may be required to settle this existing balance prior to cancellation of the account. Accordingly, if the cancellation system 106 determines that there is an existing balance associated with the account that the customer 110 has requested to be cancelled, the cancellation system 106 may update the application 504 to display the existing balance 506.

As noted above, in addition to determining the existing balance on the customer's account, the cancellation system 106 may submit a request to a deposit service to retrieve the security deposit 116 associated with the customer's account. Once the security deposit 116 has been retrieved from the deposit service, the cancellation system 106 may submit a request to the deposit disbursement system 108 to identify one or more disbursement options for disbursement of the security deposit 116, minus any amount required to settle the existing balance associated with the customer's account. For instance, if the customer 110 has an existing balance associated with their account, the cancellation system 106 may reserve an amount from the security deposit 116 that may be used to automatically settle the existing balance due on the account. Any amount remaining from the security deposit 116 (e.g., disbursement amount 118) may be made available for disbursement according to any of the one or more disbursement options selected by the customer 110.

The request from the cancellation system 106 may include an identifier corresponding to the account associated with the secured dual-feature payment instrument that is to be cancelled. Further, the request may indicate the amount of the security deposit 116 that is available for disbursement to the customer 110 or any other entity as may be indicated by the customer 110 (e.g., the original amount of the security deposit 116 minus the existing balance on the account). The option generation algorithm of the deposit disbursement system 108 may use the identifier corresponding to the account to obtain account information corresponding to the secured dual-feature payment instrument and/or the customer 110. As noted above, the account information may indicate the existing balance for the secured dual-feature payment instrument, the credit limit associated with the secured dual-feature payment instrument, the available credit associated with the secured dual-feature payment instrument, history of payments made to the account over a period of time, any history of missed payments or past-due payments made to the account, and the like. In some instances, the account information corresponding to the secured dual-feature payment instrument and/or the customer 110 may also specify credit scores, changes in credit scores over time, and the like. The account information may further include demographic information associated with the customer 110 and information that may be used to determine the spending habits of the customer 110 (e.g., transaction histories, etc.). This account information, along with information corresponding to the amount of the security deposit 116 that may be disbursed, may be used as input to the option generation algorithm.

The deposit disbursement system 108, through the option generation algorithm, may automatically, and dynamically, identify one or more disbursement options 508 that may be presented to the customer 110 along with the existing balance 506 remaining on their account. In some instances, the deposit disbursement system 108 may further determine, using the option generation algorithm, that the customer 110 may be presented with an option to disburse the available amount from the security deposit 116 amongst any combination of the aforementioned disbursement options 508. In an embodiment, once the deposit disbursement system 108 has identified the one or more disbursement options 508 that may be presented to the customer 110, the deposit disbursement system 108, through the cancellation system 106, may update the application 504 to present the existing balance 506 remaining on the account and the one or more disbursement options 508 for disbursement of any remaining amount from the security deposit 116.

It should be noted that if the entirety of the security deposit 116 is required to settle the existing balance due on the account, the cancellation system 106 can forego submitting a request to the deposit disbursement system 108 to identify one or more disbursement options to be presented to the customer 110, as the entirety of the security deposit 116 is to be used to settle the existing balance. Accordingly, the cancellation system 106 may apply the entirety of the security deposit 116 to the customer's account, such as by applying an amount 120 equivalent to the security deposit 116 to the customer's account in the user account datastore 122. Thus, in this example, the application 504 may not display the one or more disbursement options 508 illustrated in FIG. 5. Once the security deposit 116 has been applied to the customer's account, the cancellation system 106 may update the application 504 utilized by the customer 110 to indicate that the existing balance has been paid. Further, through the application 504, the cancellation system 106 may indicate that the account associated with the secured dual-feature payment instrument has been cancelled.

In some instances, rather than automatically applying an amount 120 of the security deposit 116 to settle an existing balance, the cancellation system 106 may allow the customer 110 to determine how the entirety of the security deposit 116 is to be disbursed. However, prior to disbursement of the security deposit 116 according to the selected one or more disbursement options, the customer 110 may be required to provide payment to settle the existing balance. For example, the customer 110 may be required to provide a payment instrument payment, debit payment, or other form of payment to the deposit disbursement system 108 before the deposit disbursement system 108 is able to disburse the security deposit 116 according to the selected one or more disbursement options. In response to receiving a form of payment for the existing balance, the deposit disbursement system 108 may provide this form of payment to the cancellation system 106. The cancellation system 106 may process the form of payment provided by the customer 110 to settle the existing balance. Once the existing balance has been successfully settled, the cancellation system 106 may transmit a balance settlement confirmation to the deposit disbursement system 108. In response to the balance settlement confirmation, the deposit disbursement system 108 may disburse the security deposit 116 according to the selected one or more disbursement options.

As illustrated in FIG. 5, in addition to the existing balance 506, the cancellation system 106 may present, through the application 504, the one or more disbursement options 508 identified by the deposit disbursement system 108 and that may be used for disbursement of the available amount of the security deposit 116. As noted above, additional information from the customer's account may be obtained in order to supplement these one or more disbursement options. This additional information (or a portion thereof) may be presented along with the applicable disbursement options via the application 504. This may allow the customer 110 to readily determine where a specified amount from the security deposit 116 is to be disbursed. If account information is unavailable for one or more disbursement options, the deposit disbursement system 108, through the cancellation system 106 and the application 504, may prompt the customer 110 to provide the account information in order to select the one or more disbursement options. If the customer 110 provides account information for one or more disbursement options, the deposit disbursement system 108 may update the customer's account within the user account datastore 122 to incorporate this account information.

Similar to the application 404 described above in connection with FIG. 4, the application 504 may include additional user interface elements to perform additional functions. For example, the application 504 may include a button to terminate the request to cancel the account associated with the secured dual-feature payment instrument. If the customer 110 selects this button, the application 504 may transmit a response to the cancellation system 106 that indicates the customer's cancellation of their request to cancel the secured dual-feature payment instrument. Additionally, any selections made by the customer 110 among the presented one or more disbursement options 508 may be discarded, as the security deposit 116 may still be required in order to maintain the secured dual-feature payment instrument.

The application 504 may further include a button to proceed with cancellation of the secured dual-feature payment instrument, including payment of the existing balance (if any) using the security deposit 116 (e.g., balance payment 120) and disbursement of the remaining amount of the security deposit 116 (e.g., disbursement amount 118) according to the customer's selections among the presented one or more disbursement options 508 and/or manually entered disbursement method(s). If the customer 110 selects this button, the application 504 may transmit a response to the cancellation system 106 indicating the customer's request to proceed with cancellation of the secured dual-feature payment instrument. This may cause the cancellation system 106 to settle the existing balance (if any) associated with the account using at least a portion of the security deposit 116. Additionally, the cancellation system 106 may update the user account datastore 122 to indicate that the account has been cancelled.

In addition to settling any existing balance associated with the customer's account and cancelling the customer's account, the cancellation system 106 may provide the deposit disbursement system 108 with the one or more disbursement options selected by the customer 110 for disbursement of the remaining amount from the security deposit 116 (e.g., disbursement amount 118). Based on the customer's selection of one or more disbursement options from those presented through the application 504, the deposit disbursement system 108 may facilitate deployment of the disbursement amount 118 to one or more endpoints as selected by the customer 110 through selection of one or more of the presented disbursement options 508 and/or through manual entry of one or more disbursement options through the application 504. For example, if the customer 110 has indicated that the disbursement amount 118 is to be deposited in the customer's bank account, the deposit disbursement system 108 may transmit a request to the customer's banking institution to deposit the disbursement amount 118 into the customer's bank account. If the customer 110 has specified that a particular percentage of the disbursement amount 118 is to be deployed to a first endpoint and the remaining percentage of the disbursement amount 118 is to be deployed to a second endpoint, the deposit disbursement system 108 may divide the disbursement amount 118 according to the customer's percentage allocations and may deploy the disbursement amount 118 to these endpoints accordingly. As another example, the customer 110 may specify a particular monetary amount that is to be deployed to a particular endpoint and indicate that the remaining amount is to be deployed equally amongst a number of other endpoints. The deposit disbursement system 108 may deploy the particular monetary amount to the particular endpoint, calculate the remaining monetary amount, divide this remaining monetary amount based on the number of other endpoints specified by the customer 110, and deploy the divided remaining monetary amount to these other endpoints.

Based on the customer's selection from the presented disbursement options 508 and/or manual entry of one or more disbursement methods for automatic disbursement of the disbursement amount 118, the deposit disbursement system 108 may automatically, and in real-time, incorporate these selections and/or manual entries into the historical data corresponding to the disbursements made by the deposit disbursement system 108 for different customers. As noted above, this historical data may be used to dynamically train the option generation algorithm used by the deposit disbursement system 108 to identify disbursement options that may be presented to customers based on these customers' account information and amounts available for disbursement. Thus, as the disbursements associated with the security deposit 116 are performed by the deposit disbursement system 108 during graduation or cancellation of a secured dual-feature payment instrument, the deposit disbursement system 108 may dynamically, and in real-time, update (e.g., retrain, reinforce, etc.) the option generation algorithm such that, for a new request to identify one or more disbursement options that may be presented to a customer for a given security deposit available for disbursement, the option generation algorithm may be used to identify and provide relevant and appealing disbursement options to the customer.

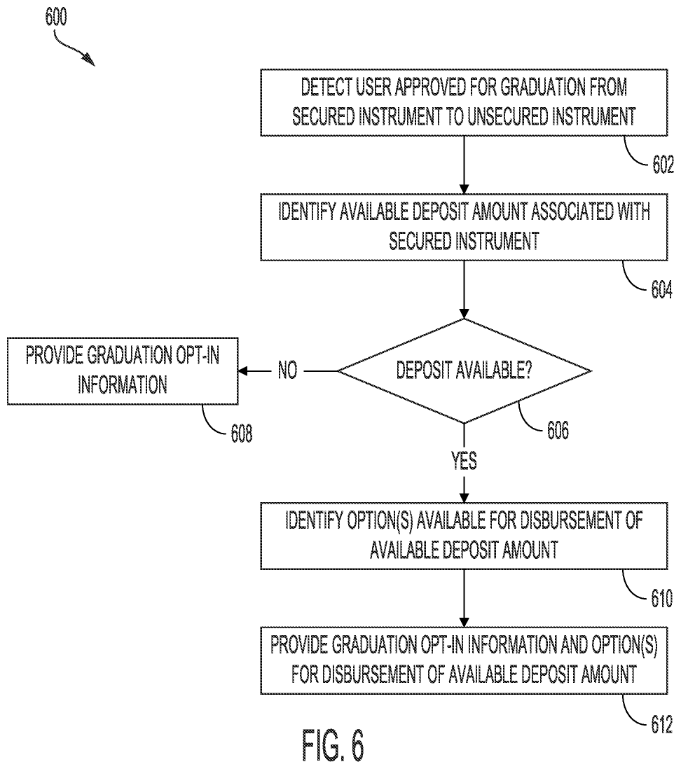

FIG. 6 shows an illustrative example of a process 600 for identifying and providing one or more disbursement options for disbursement of an available security deposit amount in response to detecting that a user is approved for graduation of a secured payment instrument in accordance with at least one embodiment. The process 600 may be performed by a graduation system of the dual-feature payment instrument service, in conjunction with a deposit disbursement system that is implemented to automatically, and dynamically, identify one or more disbursement options presentable to a user of the dual-feature payment instrument service.

At step 602, the graduation system may detect that a user is approved for graduation of their secured dual-feature payment instrument to an unsecured dual-feature payment instrument. For instance, the graduation system can automatically monitor transactions of the secured dual-feature payment instrument to determine whether an offer of graduation may be provided to the user. This determination of whether a secured dual-feature payment instrument should be graduated to an unsecured dual-feature payment instrument and/or to trigger the processing of the graduation of the secured dual-feature payment instrument to an unsecured dual-feature payment instrument is based on pre-determined criteria including, but not limited to, spending habits over a period of time, payment performance over a period of time, changes in credit scores over a period of time, and the like. As noted above, the graduation may use a machine learning algorithm or artificial intelligence to determine whether a secured dual-feature payment instrument should be graduated to an unsecured dual-feature payment instrument and/or to trigger the processing of the graduation of the secured dual-feature payment instrument to an unsecured dual-feature payment instrument. Based on the output of the machine learning algorithm or artificial intelligence built from an individual account, user, and/or secured dual-feature payment instrument, a determination of whether a secured dual-feature payment instrument should be graduated to an unsecured dual-feature payment instrument and/or whether to trigger the processing of the graduation of the secured dual-feature payment instrument to an unsecured dual-feature payment instrument, the graduation system can detect that a user is approved for graduation of their secured dual-feature payment instrument to an unsecured dual-feature payment instrument.

At step 604, the graduation system may identify the available security deposit amount associated with the secured dual-feature payment instrument. For instance, the graduation system may access the user's account within a user account datastore (e.g., user account datastore 122, as illustrated in FIG. 1) to determine the amount of the security deposit maintained in escrow for the account and any existing balances associated with the account. If graduation of the secured dual-feature payment instrument to an unsecured dual-feature payment instrument requires settlement of any existing balances associated with the account, the graduation system may deduct the existing balance from the security deposit to determine the available security deposit amount that may be disbursed to the user or to other endpoints as may be indicated by the user. Accordingly, at step 606, the graduation system may determine whether there is an available security deposit amount for disbursement to the user.

If the graduation system determines that there is no available security deposit amount for disbursement to the user (e.g., the security deposit, in its entirety, is required to settle an existing balance, etc.), the graduation system may provide the user with graduation opt-in information that may be used by the user to determine whether to accept the offer to graduate their secured dual-feature payment instrument to an unsecured dual-feature payment instrument. The offer for graduation may include information such as the terms for the graduation, an interest rate of the unsecured dual-feature payment instrument, a credit limit of the unsecured dual-feature payment instrument, when the graduation will be effective, whether the graduation is automatically accepted or automatically rejected based on no response by a certain date, and other such information. However, in this example, since there is no available security deposit amount for disbursement to the user, the graduation system may forego identifying and presenting any disbursement options for the security deposit.

If the graduation system determines that there is an available security deposit amount that may be disbursed to the user, the graduation system, at step 610 and through the deposit disbursement system, may identify one or more disbursement options for disbursement of this available security deposit amount. For instance, the graduation system may submit a deposit disbursement request to the deposit disbursement system. In response to this request, the deposit disbursement system may automatically identify one or more disbursement options that may be presented to the use for disbursement of the available security deposit amount. As noted above, the deposit disbursement system may implement a machine learning algorithm or artificial intelligence that is trained to dynamically generate one or more options that may be provided to the user for disbursement of the available security deposit amount. The deposit disbursement system may use account information associated with the user as input to the machine learning algorithm or artificial intelligence to determine the one or more disbursement options that may be presented to the user. These disbursement options may include a bank account deposit, conversion to an instrument service debit card or other payment instrument, a retirement account deposit, one or more bill payments, a college savings plan deposit, one or more charitable donations, and the like. The machine learning algorithm or artificial intelligence may further provide an option to disburse the available security deposit amount amongst any combination of the aforementioned disbursement options.

At step 612, the graduation system may provide the user with graduation opt-in information that may be used by the user to determine whether to accept the offer to graduate their secured dual-feature payment instrument to an unsecured dual-feature payment instrument. Additionally, the graduation system may present the user with the identified one or more disbursement options for disbursement of the available security deposit amount. For instance, through an interface (such as through application 404 described above in connection with FIG. 4), the graduation system may present the user with the offer to graduate their secured dual-feature payment instrument to an unsecured dual-feature payment instrument and with the one or more available disbursement options.

It should be noted that in some instances, the graduation system may provide the user with graduation opt-in information prior to the identification and presentation of the available one or more disbursement options for the available security deposit amount. For instance, the graduation system may wait for the user to accept the offer for graduation of the secured dual-feature payment instrument to an unsecured dual-feature payment instrument before transmitting a request to the deposit disbursement system to identify the one or more disbursement options that may be presented to the user. Thus, the performance of steps 610 and 612 of the process 600 may be contingent on the user accepting the offer to graduate their secured dual-feature payment instrument to an unsecured dual-feature payment instrument.

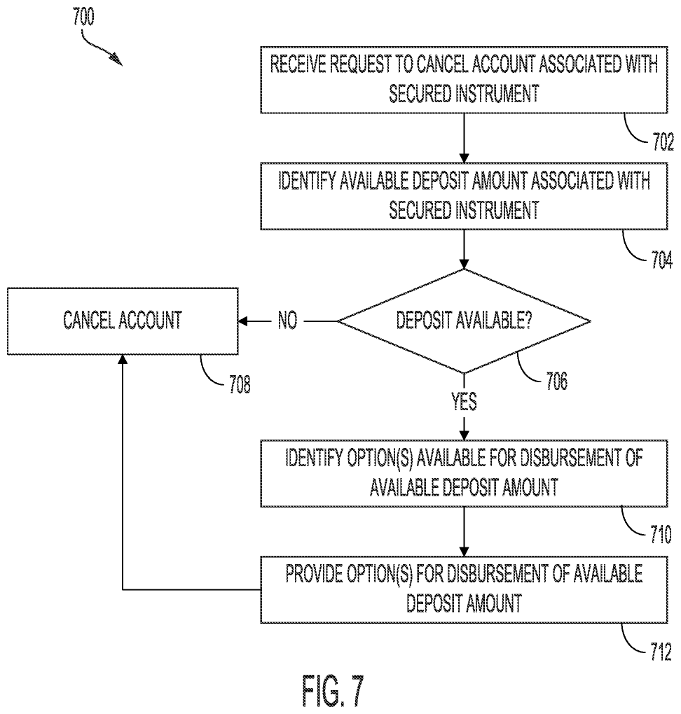

FIG. 7 shows an illustrative example of a process 700 for identifying and providing one or more disbursement options for disbursement of an available deposit amount in response to a request to cancel an account associated with a secured payment instrument in accordance with at least one embodiment. The process 700 may be performed by a cancellation system of the dual-feature payment instrument service, in conjunction with a deposit disbursement system that is implemented to automatically, and dynamically, identify one or more disbursement options presentable to a user of the dual-feature payment instrument service.

At step 702, the cancellation system may receive a request to cancel an existing account associated with a secured dual-feature payment instrument. As noted above, the dual-feature payment instrument service may provide users with access to the cancellation system via an interface (e.g., application 504 as described above in connection with FIG. 5). Through this interface, a user may submit a request to the cancellation system to cancel an existing account associated with a secured dual-feature payment instrument.

At step 704, the cancellation system may identify the available security deposit amount associated with the secured dual-feature payment instrument. For instance, similar to the process performed by the graduation system (as described above in connection with FIG. 6), the cancellation system may access the user's account within a user account datastore (e.g., user account datastore 122, as illustrated in FIG. 1) to determine the amount of the security deposit maintained in escrow for the account and any existing balances associated with the account. If there is an existing balance associated with the account, the cancellation system may determine that settlement of this existing balance is required before cancellation of the account may be performed. Accordingly, the cancellation system may deduct the existing balance from the security deposit to determine the available security deposit amount that may be disbursed to the user or to other endpoints as may be indicated by the user. Thus, at step 706, the cancellation system may determine whether there is an available security deposit amount for disbursement to the user.

If the cancellation system determines that the entirety of the security deposit is to be used to settle an existing balance associated with the account, the cancellation system, at step 708, may settle the existing balance using the security deposit and proceed to cancel the account. Additionally, if the entirety of the security deposit is required to settle the existing balance associated with the account, the cancellation system may forego submitting a request to a deposit disbursement system to identify possible disbursement options that may be presented to the user for disbursement of the security deposit, as the security deposit may no longer be available for disbursement. Once the security deposit has been applied to the user's account, the cancellation system may update the interface utilized by the user to indicate that the existing balance has been settled. Further, through the interface, the cancellation system may indicate that the account associated with the secured dual-feature payment instrument has been cancelled.

If the cancellation system determines that at least a portion of the security deposit is available after settlement of an existing balance, the cancellation system may, at step 710, transmit a request to a deposit disbursement system to identify one or more disbursement options that may be presented, to the user, for disbursement of the available security deposit amount. The cancellation system, in its request to the deposit disbursement system, may indicate the remaining amount of the security deposit that can be disbursed to the user. Accordingly, the deposit disbursement system may indicate, to the user, the remaining amount of the security deposit that can be disbursed according to one or more options made available to the user. As noted above, the deposit disbursement system may use an option generation algorithm to automatically identify one or more disbursement options that may be presented to the user for disbursement of the available amount of the security deposit. Thus, the deposit disbursement system may automatically use account information associated with the user as input to the option generation algorithm to identify one or more disbursement options that may be presented to the user.

At step 712, the deposit distribution system, through the cancellation system, may provide the identified one or more disbursement options to the user. For instance, through an interface (such as through application 504 described above in connection with FIG. 5), the cancellation system may present the user with the one or more available disbursement options, as well as information regarding any existing balances on the account and the available security deposit amount that may be disbursed according to the user's selections. Based on the user's selections, the deposit disbursement system may facilitate deployment of the remaining amount of the security deposit to one or more endpoints. Further, at step 708, the cancellation system may proceed to cancel the account associated with the secured dual-feature payment instrument.

It should be noted that the process 700 may be performed using additional and/or alternative steps. For instance, rather than automatically applying an amount of the security deposit to settle an existing balance, the cancellation system may allow the user to select one or more disbursement options for disbursement of the entire security deposit. However, prior to disbursement of the security deposit according to the selected one or more disbursement options, the user may be required to provide payment to settle the existing balance. For example, the user may be required to provide a form of payment to the deposit disbursement system prior to the deposit disbursement system being able to disburse the security deposit according to the selected one or more disbursement options. In response to receiving a form of payment for the existing balance, the deposit disbursement system may provide this form of payment to the cancellation system. The cancellation system may process the form of payment provided by the user to settle the existing balance. Once the existing balance has been successfully settled, the cancellation system may transmit a balance settlement confirmation to the deposit disbursement system. In response to the balance settlement confirmation, the deposit disbursement system may disburse the security deposit according to the selected one or more disbursement options.

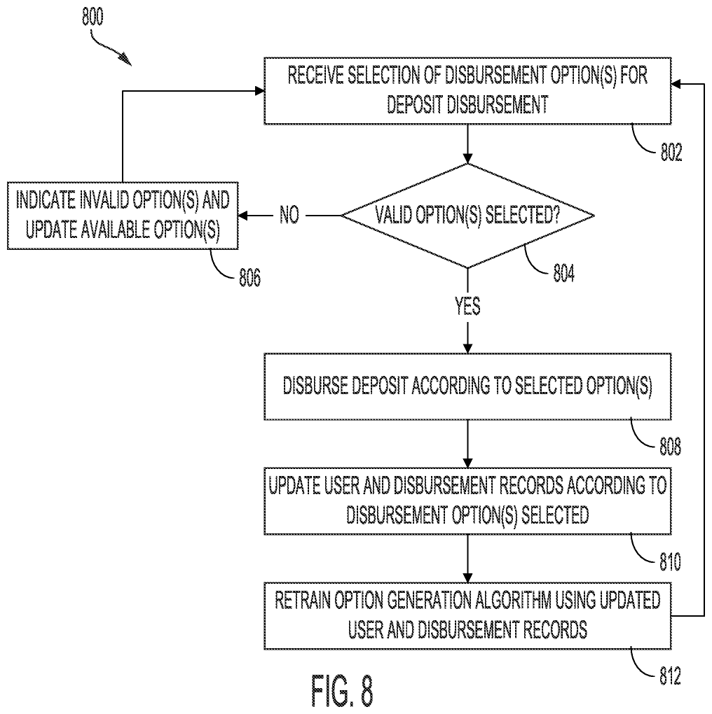

FIG. 8 shows an illustrative example of a process 800 for disbursing a security deposit amount associated with a secured dual-feature payment instrument according to one or more selected disbursement options in accordance with at least one embodiment. The process 800 may be performed by a deposit disbursement system, such as the deposit disbursement system 108 described above in connection with FIGS. 1-5. As noted above, the deposit disbursement system may implement a machine learning algorithm or artificial intelligence (e.g., option generation algorithm 206, as described above in connection with FIGS. 2 and 3) that is trained to automatically, and dynamically, identify one or more disbursement options that may be presented to a user based on various factors. The machine learning algorithm or artificial intelligence may be trained using supervised, unsupervised, reinforcement, or other such training techniques, as described above.

At step 802, the deposit disbursement system may receive a selection of one or more disbursement options for disbursement of an available security deposit amount from an account associated with a secured dual-feature payment instrument. As noted above, the deposit disbursement option, using the aforementioned machine learning algorithm or artificial intelligence, may automatically identify one or more disbursement options that may be presented to a user in response to either detecting that the user has been approved for graduation from a secured dual-feature payment instrument to an unsecured dual-feature payment instrument or receiving a request to cancel an existing account associated with the secured dual-feature payment instrument. These disbursement options may include a bank account deposit, conversion to an instrument service debit card or other payment instrument, a retirement account deposit, one or more bill payments, a college savings plan deposit, one or more charitable donations, and the like. The machine learning algorithm or artificial intelligence may further provide an option to disburse the available security deposit amount amongst any combination of the aforementioned disbursement options. These disbursement options may be determined using account information associated with the user and/or with the secured dual-feature payment instrument. For instance, the account information may indicate an existing balance for the secured dual-feature payment instrument, the credit limit associated with the secured dual-feature payment instrument, the available credit associated with the secured dual-feature payment instrument, history of payments made to the account over a period of time, any history of missed payments or past-due payments made to the account, and the like. In some instances, the account information corresponding to the secured dual-feature payment instrument and/or the user may also specify credit scores, changes in credit scores over time, and the like. The account information may further include demographic information associated with the user and information that may be used to determine the spending habits of the user(e.g., transaction histories, etc.). This account information, along with information corresponding to the amount of the security deposit that may be disbursed, may be used as input to the machine learning algorithm or artificial intelligence.

At step 804, the deposit disbursement system may determine whether the user has selected valid disbursement options from those presented to the user. In an embodiment, the deposit disbursement system continuously monitors the account associated with the secured dual-feature payment instrument and/or the user to determine whether the previously presented disbursement options are still valid. For instance, if the user updates the account to remove account information corresponding to a bank account or other financial institution for which one or more disbursement options were presented, the deposit disbursement system may determine, in real-time, that these one or more disbursement options are no longer valid. As another illustrative, but non-limiting, example, if the deposit disbursement system determines that a charitable organization is no longer available for receipt of donations through disbursement distribution (e.g., the charitable organization is no longer in existence, the charitable organization is no longer sponsored by the dual-feature payment instrument service, the user has removed the charitable organization from a list of preferred charitable organizations, etc.), and the deposit disbursement system has previously provided a disbursement option corresponding to this charitable organization, the deposit disbursement system may determine that this disbursement option is no longer valid.

In an embodiment, if the deposit disbursement system determines that the user has selected at least one invalid disbursement option from those previously presented to the user, the deposit disbursement system, at step 806, can indicate that the user has selected one or more invalid disbursement options. Further, the deposit disbursement system, in an embodiment, can update the available disbursement options that are available to the user for disbursement of the available security deposit amount. For instance, the deposit disbursement system may use the updated account information associated with the secured dual-feature payment instrument and/or the user, as well as any other information corresponding to the previously presented disbursement options (e.g., identification of newly invalid disbursement options, updates corresponding to the removal of previously presented disbursement options, etc.), as input to the machine learning algorithm or artificial intelligence to obtain an updated set of available disbursement options that may be presented to the user.

In an embodiment, rather than awaiting user selection of one or more disbursement options to determine whether valid disbursement options have been selected, the deposit distribution system can dynamically, and in real-time, remove any newly invalid disbursement options before the user makes a selection from the presented disbursement options. For example, prior to the user making any disbursement option selections, the deposit disbursement system may continuously monitor the account information associated with the secured dual-feature payment instrument and/or the user to detect any changes to the corresponding account. Further, the deposit disbursement system may continuously monitor the dual-feature payment instrument service to detect any changes to the disbursement options that may be presented to users of the dual-feature payment instrument service (e.g., changes to charitable organizations to which donations may be made, changes to the financial institutions to which distributions may be made, etc.). If any changes are detected, the deposit disbursement system, in real-time, may determine whether the disbursement options presented to user are still valid. If any of the presented disbursement options are no longer valid, the deposit disbursement system may, in real-time, remove these invalid disbursement options to prevent user selection of these invalid disbursement options. For example, the deposit disbursement system may, in real-time, update the interface (e.g., application 404 or application 504 as described above in FIGS. 4 and 5, respectively) to remove these invalid disbursement options. This may reduce the likelihood of the user selecting an invalid disbursement option and delaying disbursement of the available security deposit amount.

If the user has selected one or more valid disbursement options for disbursement of an available security deposit amount, the deposit disbursement system, at step 808, may disburse the available security deposit amount according to these selected disbursement options. As noted above, the deposit disbursement system may facilitate deployment of all or portions of the security deposit to one or more endpoints determined by the user through selection of one or more of the available disbursement options. For example, if the user has indicated that the security deposit is to be deposited in the user's bank account, the deposit disbursement system may transmit a request to the user's banking institution (e.g., ACH bank transfer request, EFT request, etc.) to deposit the security deposit into the user's bank account. In an embodiment, if the user has specified that a particular percentage of the security deposit is to be deployed to a first endpoint and the remaining percentage of the security deposit is to be deployed to a second endpoint, the deposit disbursement system divides the security deposit according to the user's percentage allocations and deploys the security deposit to these endpoints accordingly. As another example, if the user specifies that a particular monetary amount is to be deployed to a particular endpoint and indicates that the remaining amount is to be deployed equally amongst a number of other endpoints, the deposit disbursement system may deploy the particular monetary amount to the particular endpoint, calculate the remaining monetary amount, divide this remaining monetary amount based on the number of other endpoints specified by the user, and deploy the divided remaining monetary amount to these other endpoints.

At step 810, the deposit disbursement system may update the user and disbursement records, as maintained in the user account datastore and the disbursement records datastore, respectively, according to the disbursement options selected by the user. As noted above, based on a user's selection from the presented disbursement options and/or manual entry of one or more disbursement methods for automatic disbursement of the available security deposit amount, the deposit disbursement system may automatically, and in real-time, incorporate these selections and/or manual entries into the historical data corresponding to the disbursements made by the deposit disbursement system for different users. This historical data may be used to dynamically train the option generation algorithm used by the deposit disbursement system to identify disbursement options that may be presented to users based on these users' account information and amounts available for disbursement. Thus, as the disbursements associated with a security deposit are performed by the deposit disbursement system during graduation or cancellation of a secured dual-feature payment instrument, the deposit disbursement system, at step 812, may dynamically, and in real-time, update (e.g., retrain, reinforce, etc.) the machine learning algorithm or artificial intelligence such that, for a new request to identify one or more disbursement options that may be presented to a user for a given security deposit available for disbursement, the machine learning algorithm or artificial intelligence may be used to identify and provide relevant and appealing disbursement options to the user.

FIG. 9 illustrates a computing system architecture 900, including various components in electrical communication with each other, in accordance with some embodiments. The example computing system architecture 900 illustrated in FIG. 9 includes a computing device 902, which has various components in electrical communication with each other using a connection 906, such as a bus, in accordance with some implementations. The example computing system architecture 900 includes a processing unit 904 that is in electrical communication with various system components, using the connection 906, and including the system memory 914. In some embodiments, the system memory 914 includes read-only memory (ROM), random-access memory (RAM), and other such memory technologies including, but not limited to, those described herein. In some embodiments, the example computing system architecture 900 includes a cache 908 of high-speed memory connected directly with, in close proximity to, or integrated as part of the processor 904. The system architecture 900 can copy data from the memory 914 and/or the storage device 910 to the cache 908 for quick access by the processor 904. In this way, the cache 908 can provide a performance boost that decreases or eliminates processor delays in the processor 904 due to waiting for data. Using modules, methods and services such as those described herein, the processor 904 can be configured to perform various actions. In some embodiments, the cache 908 may include multiple types of cache including, for example, level one (L1) and level two (L2) cache. The memory 914 may be referred to herein as system memory or computer system memory. The memory 914 may include, at various times, elements of an operating system, one or more applications, data associated with the operating system or the one or more applications, or other such data associated with the computing device 902.

Other system memory 914 can be available for use as well. The memory 914 can include multiple different types of memory with different performance characteristics. The processor 904 can include any general purpose processor and one or more hardware or software services, such as service 912 stored in storage device 910, configured to control the processor 904 as well as a special-purpose processor where software instructions are incorporated into the actual processor design. The processor 904 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 904 can be a microprocessor, a microcontroller, a digital signal processor (“DSP”), or a combination of these and/or other types of processors. In some embodiments, the processor 904 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 900, an input device 916 can represent any number of input mechanisms, such as a microphone for speech, a touch-sensitive screen for gesture or graphical input, keyboard, mouse, motion input, pen, and other such input devices. An output device 918 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 900. In some embodiments, the input device 916 and/or the output device 918 can be coupled to the computing device 902 using a remote connection device such as, for example, a communication interface such as the network interface 920 described herein. In such embodiments, the communication interface can govern and manage the input and output received from the attached input device 916 and/or output device 918. As may be contemplated, there is no restriction on operating on any particular hardware arrangement and accordingly the basic features here may easily be substituted for other hardware, software, or firmware arrangements as they are developed.

In some embodiments, the storage device 910 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 910 can include hardware and/or software services such as service 912 that can control or configure the processor 904 to perform one or more functions including, but not limited to, the methods, processes, functions, systems, and services described herein in various embodiments. In some embodiments, the hardware or software services can be implemented as modules. As illustrated in example computing system architecture 900, the storage device 910 can be connected to other parts of the computing device 902 using the system connection 906. In an embodiment, a hardware service or hardware module such as service 912, that performs a function can include a software component stored in a non-transitory computer-readable medium that, in connection with the necessary hardware components, such as the processor 904, connection 906, cache 908, storage device 910, memory 914, input device 916, output device 918, and so forth, can carry out the functions such as those described herein.

The disclosed dual-feature payment instrument service, the systems of the dual-feature payment instrument service, and the systems and methods for graduating a secured dual-feature payment instrument to an unsecured dual-feature payment instrument can be performed using a computing system such as the example computing system illustrated in FIG. 9, using one or more components of the example computing system architecture 900. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for graduating a secured dual-feature payment instrument to an unsecured dual-feature payment instrument described herein by, for example, executing code using a processor such as processor 904 wherein the code is stored in memory such as memory 914 as described herein. One or more of a user device, a provider server or system, a database system, or other such devices, services, or systems may include some or all of the components of the computing system such as the example computing system illustrated in FIG. 9, using one or more components of the example computing system architecture 900 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 928. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 904 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 914 can be coupled to the processor 904 by, for example, a connector such as connector 906, or a bus. As used herein, a connector or bus such as connector 906 is a communications system that transfers data between components within the computing device 902 and may, in some embodiments, be used to transfer data between computing devices. The connector 906 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 914 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 914 can also include magnetic or optical data storage media including read-only (e.g., CD ROM and DVD ROM) or otherwise (e.g., CD or DVD). The memory can be local, remote, or distributed.

As described herein, the connector 906 (or bus) can also couple the processor 904 to the storage device 910, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data is may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 910. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 906 can also couple the processor 904 to a network interface device such as the network interface 920. The interface can include one or more of a modem or other such network interfaces including, but not limited to those described herein. It will be appreciated that the network interface 920 may be considered to be part of the computing device 902 or may be separate from the computing device 902. The network interface 920 can include one or more of an analog modem, Integrated Services Digital Network (ISDN) modem, cable modem, token ring interface, satellite transmission interface, or other interfaces for coupling a computer system to other computer systems. In some embodiments, the network interface 920 can include one or more input and/or output (I/O) devices. The I/O devices can include, by way of example but not limitation, input devices such as input device 916 and/or output devices such as output device 918. For example, the network interface 920 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™ SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 902 can be connected to one or more additional computing devices such as computing device 924 via a network 922 using a connection such as the network interface 920. In such embodiments, the computing device 924 may execute one or more services 926 to perform one or more functions under the control of, or on behalf of, programs and/or services operating on computing device 902. In some embodiments, a computing device such as computing device 924 may include one or more of the types of components as described in connection with computing device 902 including, but not limited to, a processor such as processor 904, a connection such as connection 906, a cache such as cache 908, a storage device such as storage device 910, memory such as memory 914, an input device such as input device 916, and an output device such as output device 918. In such embodiments, the computing device 924 can carry out the functions such as those described herein in connection with computing device 902. In some embodiments, the computing device 902 can be connected to a plurality of computing devices such as computing device 924, each of which may also be connected to a plurality of computing devices such as computing device 924. Such an embodiment may be referred to herein as a distributed computing environment.

The network 922 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 922 can be wired connections, wireless connections, or combinations thereof. Communications via the network 922 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 922, within the computing device 902, within the computing device 924, or within the computing resources provider 928 can include information, which also may be referred to herein as content. The information may include text, graphics, audio, video, haptics, and/or any other information that can be provided to a user of the computing device such as the computing device 902. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 902 and presented to a user of the computing device 902 using forms that are perceptible via sight, sound, smell, taste, touch, or other such mechanisms. In some embodiments, communications over the network 922 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 902 and/or the computing device 924 can be connected to a computing resources provider 928 via the network 922 using a network interface such as those described herein (e.g. network interface 920). In such embodiments, one or more systems (e.g., service 930 and service 932) hosted within the computing resources provider 928 (also referred to herein as within “a computing resources provider environment”) may execute one or more services to perform one or more functions under the control of, or on behalf of, programs and/or services operating on computing device 902 and/or computing device 924. Systems such as service 930 and service 932 may include one or more computing devices such as those described herein to execute computer code to perform the one or more functions under the control of, or on behalf of, programs and/or services operating on computing device 902 and/or computing device 924.

For example, the computing resources provider 928 may provide a service, operating on service 930 to store data for the computing device 902 when, for example, the amount of data that the computing device 902 exceeds the capacity of storage device 910. In another example, the computing resources provider 928 may provide a service to first instantiate a virtual machine (VM) on service 932, use that VM to access the data stored on service 932, perform one or more operations on that data, and provide a result of those one or more operations to the computing device 902. Such operations (e.g., data storage and VM instantiation) may be referred to herein as operating “in the cloud,” “within a cloud computing environment,” or “within a hosted virtual machine environment,” and the computing resources provider 928 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 928 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 930 and service 932 may implement versions of various services (e.g., the service 912 or the service 926) on behalf of, or under the control of, computing device 902 and/or computing device 924. Such implemented versions of various services may involve one or more virtualization techniques so that, for example, it may appear to a user of computing device 902 that the service 912 is executing on the computing device 902 when the service is executing on, for example, service 930. As may also be contemplated, the various services operating within the computing resources provider 928 environment may be distributed among various systems within the environment as well as partially distributed onto computing device 924 and/or computing device 902.

In an embodiment, the computing device 902 can be connected to one or more additional computing devices and/or services such as merchant computing device 936 and/or a point-of-sale service 934 via the network 922 and using a connection such as the network interface 920. In an embodiment, the point-of-sale service 934 is separate from the merchant computing device 936. In an embodiment, the point-of-sale service 934 is executing on the merchant computing device 936. In an embodiment, the point-of-sale service 934 is executing as one or more services (e.g., the service 930 and/or the service 932) operating within the environment of the computing resources provider. As used herein, a point-of-sale service 934 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 936 to interact with the point-of-sale service 934. In an embodiment, the merchant computing device 936 is a dedicated point-of-service (POS) terminal. In an embodiment, the merchant computing device 936 is a cash register system. In an embodiment, the merchant computing device 936 is an application or web service operating on a computing device such as the computing device 902 described herein. In such an embodiment, the application or web service may be provided by a financial services system (e.g., a bank, a transaction processing system, an inventory management system, or some other such financial services system). In an embodiment, the merchant computing device 936 includes an auxiliary device or system to execute tasks associated with the point-of-sale service 934 (e.g., a payment instrument processing device attached to a smart phone or tablet). In an embodiment, the merchant computing device 936 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 936 is a virtual device (e.g., a virtual kiosk) such as the virtual devices described herein. Although not illustrated here, in an embodiment, the merchant computing device 936 may be one of a plurality of devices that may be interconnected using a network such as the network 922.

In an embodiment, the computing device 902 can be connected to one or more additional computing devices and/or services such as a payment instrument service 938 via the network 922 and using a connection such as the network interface 920. In an embodiment, the payment instrument service 938 connects directly with the point of sale service 934. In an embodiment, elements of the payment instrument service 938 are executing on the merchant computing device 936. In an embodiment, the payment instrument service 938 is executing as one or more services (e.g., the service 930 and/or the service 932) operating within the environment of the computing resources provider. As used herein, a payment instrument service 938 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 938 are running as an application or web service operating on a computing device such as the computing device 902 described herein. In such an embodiment, the application or web service of the payment instrument service 938 may be provided by a financial services system (e.g., a bank, a transaction processing system, an inventory management system, or some other such financial services system). In an embodiment, elements of the payment instrument service 938 are running on an auxiliary device or system configured to execute tasks associated with the payment instrument service 938 (e.g., uses a payment instrument processing device attached to a smart phone or tablet). In an embodiment, elements of the payment instrument service 938 are running on virtual device such as those described herein. Although not illustrated here, in an embodiment, the payment instrument service 938 may be running on one or more of a plurality of devices that may be interconnected using a network such as the network 922.

In an embodiment, the computing device 902 can be connected to one or more additional computing devices and/or services such as an authentication service 940 via the network 922 and using a connection such as the network interface 920. In an embodiment, the authentication service 940 is an element of the payment instrument service 938. In an embodiment, the authentication service 940 is separate from the payment instrument service 938. In an embodiment, the authentication service 940 connects directly with the point of sale service 934. In an embodiment, elements of the authentication service 940 are executing on the merchant computing device 936. In an embodiment, the authentication service 940 is executing as one or more services (e.g., the service 930 and/or the service 932) operating within the environment of the computing resources provider. As used herein, an authentication service 940 is a service used by one or more merchants to authenticate transactions associated with payment instruments. An authentication service may be a third-party service that provides secure and verified authorization of the transactions.

In an embodiment, elements of the authentication service 940 are running as an application or web service operating on a computing device such as the computing device 902 described herein. In such an embodiment, the application or web service of the authentication service 940 may be provided by a financial services system (e.g., a bank, a transaction processing system, an inventory management system, or some other such financial services system). In an embodiment, elements of the authentication service 940 are running on an auxiliary device or system configured to execute tasks associated with the authentication service 940 (e.g., provides authentication using payment instrument processing device attached to a smart phone or tablet). In an embodiment, elements of the authentication service 940 are running on virtual device such as those described herein. Although not illustrated here, in an embodiment, the authentication service 940 may be running on one or more of a plurality of devices that may be interconnected using a network such as the network 922.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 600 for offering graduation of a secured dual-feature payment instrument to an unsecured dual-feature payment instrument to an account holder illustrated in FIG. 6). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 902.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method, comprising:
detecting that an offer to graduate a secured dual-feature payment instrument to an unsecured dual-feature payment instrument is available, wherein the secured dual-feature payment instrument is secured by a security deposit and is associated with a payment instrument account;
identifying an available security deposit amount for disbursement, wherein the available security deposit amount is identified based on the security deposit and a balance associated with the payment instrument account;
training a machine learning algorithm to identify a set of disbursement options for disbursement of the available security deposit amount, wherein the machine learning algorithm is trained using the account and historical data corresponding to previous disbursements of security deposits associated with other secured dual-feature payment instruments;
providing the set of disbursement options;
receiving input corresponding to a selection of one or more disbursement options from the set of disbursement options;
automatically disbursing the available security deposit amount to one or more endpoints, wherein the one or more endpoints correspond to the selected one or more disbursement options, and wherein the available security deposit amount is automatically disbursed as a result of detecting that the offer to graduate to the unsecured dual-feature payment instrument has been accepted; and
updating the machine learning algorithm, wherein the machine learning algorithm is updated using the payment instrument account, the historical data, and the selected one or more disbursement options.

2. The computer-implemented method of claim 1, further comprising:
using a portion of the security deposit to settle the balance associated with the account.

3. The computer-implemented method of claim 1, further comprising:
determining that a disbursement option of the set of disbursement options is no longer valid;
dynamically updating the set of disbursement options in real-time to remove the disbursement option that is no longer valid; and
providing the updated set of disbursement options.

4. The computer-implemented method of claim 1, wherein the set of disbursement options include a bank account deposit, and wherein the bank account deposit corresponds to a bank account specified in the payment instrument account.

5. The computer-implemented method of claim 1, wherein the set of disbursement options include an option to donate the available security deposit amount to a charitable organization, and wherein the option to donate the available security deposit amount includes a listing of charitable organizations.

6. The computer-implemented method of claim 1, wherein the offer and the set of disbursement options are provided concurrently.

7. The computer-implemented method of claim 1, further comprising:
receiving a manual selection of an alternative disbursement option, wherein the alternative disbursement option is not part of the set of disbursement options; and
updating the machine learning algorithm using the manual selection of the alternative disbursement option.

8. A system, comprising:
one or more processors; and
memory storing thereon instructions that, as a result of being executed by the one or more processors, cause the system to:
detect that an offer to graduate a secured dual-feature payment instrument to an unsecured dual-feature payment instrument is available, wherein the secured dual-feature payment instrument is secured by a security deposit and is associated with a payment instrument account;
identify an available security deposit amount for disbursement, wherein the available security deposit amount is identified based on the security deposit and a balance associated with the payment instrument account;
train a machine learning algorithm to identify a set of disbursement options for disbursement of the available security deposit amount, wherein the machine learning algorithm is trained using the account and historical data corresponding to previous disbursements of security deposits associated with other secured dual-feature payment instruments;
provide the set of disbursement options;
receive a selection of one or more disbursement options from the set of disbursement options;
automatically disburse the available security deposit amount to one or more endpoints, wherein the one or more endpoints correspond to the selected one or more disbursement options, and wherein the available security deposit amount is automatically disbursed as a result of the detecting that the offer has been accepted; and
update the machine learning algorithm, wherein the machine learning algorithm is updated using the payment instrument account, the historical data, and the selected one or more disbursement options.

9. The system of claim 8, wherein the instructions further cause the system to:
use a portion of the security deposit to settle the balance associated with the account.

10. The system of claim 8, wherein the instructions further cause the system to:
determine that a disbursement option of the set of disbursement options is no longer valid;
dynamically update the set of disbursement options in real-time to remove the disbursement option that is no longer valid; and
provide the updated set of disbursement options.

11. The system of claim 8, wherein the set of disbursement options include a bank account deposit, and wherein the bank account deposit corresponds to a bank account specified in the payment instrument account.

12. The system of claim 8, wherein the set of disbursement options include an option to donate the available security deposit amount to a charitable organization, and wherein the option to donate the available security deposit amount includes a listing of charitable organizations.

13. The system of claim 8, wherein the offer and the set of disbursement options are provided concurrently.

14. The system of claim 8, wherein the instructions further cause the system to:
receive a manual selection of an alternative disbursement option, wherein the alternative disbursement option is not part of the set of disbursement options; and
update the machine learning algorithm using the manual selection of the alternative disbursement option.

15. A non-transitory, computer-readable storage medium storing thereon executable instructions that, as a result of being executed by a computer system, cause the computer system to:
detect that an offer to graduate a secured dual-feature payment instrument to an unsecured dual-feature payment instrument is available, wherein the secured dual-feature payment instrument is secured by a security deposit and is associated with a payment instrument account;
identify an available security deposit amount for disbursement, wherein the available security deposit amount is identified based on the security deposit and a balance associated with the payment instrument account;
train a machine learning algorithm to identify a set of disbursement options for disbursement of the available security deposit amount, wherein the machine learning algorithm is trained using the account and historical data corresponding to previous disbursements of security deposits associated with other secured dual-feature payment instruments;
provide the set of disbursement options;
receive a selection of one or more disbursement options from the set of disbursement options;
automatically disburse the available security deposit amount to one or more endpoints, wherein the one or more endpoints correspond to the selected one or more disbursement options, and wherein the available security deposit amount is automatically disbursed as a result of the detecting that the offer has been accepted; and
update the machine learning algorithm, wherein the machine learning algorithm is updated using the payment instrument account, the historical data, and the selected one or more disbursement options.

16. The non-transitory, computer-readable storage medium of claim 15, wherein the executable instructions further cause the computer system to:
use a portion of the security deposit to settle the balance associated with the account.

17. The non-transitory, computer-readable storage medium of claim 15, wherein the executable instructions further cause the computer system to:
determine that a disbursement option of the set of disbursement options is no longer valid;
dynamically update the set of disbursement options in real-time to remove the disbursement option that is no longer valid; and
provide the updated set of disbursement options.

18. The non-transitory, computer-readable storage medium of claim 15, wherein the set of disbursement options include a bank account deposit, and wherein the bank account deposit corresponds to a bank account specified in the payment instrument account.

19. The non-transitory, computer-readable storage medium of claim 15, wherein the set of disbursement options include an option to donate the available security deposit amount to a charitable organization, and wherein the option to donate the available security deposit amount includes a listing of charitable organizations.

20. The non-transitory, computer-readable storage medium of claim 15, wherein the offer and the set of disbursement options are provided concurrently.

21. The non-transitory, computer-readable storage medium of claim 15, wherein the executable instructions further cause the computer system to:
receive a manual selection of an alternative disbursement option, wherein the alternative disbursement option is not part of the set of disbursement options; and
update the machine learning algorithm using the manual selection of the alternative disbursement option.
